(19) United States
(12) Patent Application Publication
(10) Pub. No.: US 2010/0045773 A1
(43) Pub. Date: Feb. 25, 2010

(54) PANORAMIC ADAPTER SYSTEM AND METHOD WITH SPHERICAL FIELD-OF-VIEW COVERAGE

(76) Inventor: Kurtis J. Ritchey, Leavenworth, KS (US)

Correspondence Address: Kurtis J. Ritchey, 26374 Tonganoxie Road, Leavenworth, KS, 66048, US

(21) Appl. No.: 12/266,308

(22) Filed: Nov. 6, 2008

Related U.S. Application Data
(60) Provisional application No. 60/985,867, filed on Nov. 6, 2007.

(51) Int. Cl. H04N 7/00; G02B 13/06

(52) U.S. Cl. 348/36; 359/749; 348/E07.001

(57) ABSTRACT

A panoramic optical system includes optical means including one or more objective and relay optics to focus at least one image representing at least some portion of a substantially spherical field-of-view scene in focus to an imaging plane, housing means including support means to hold the optical means and mounting means that attaches the panoramic optical system to an adjacent camera.

This application claims the benefit of, and priority to, U.S. Provisional patent application 60/985,867 filed Nov. 6, 2007, U.S. patent application Ser. No. 11/836,637 filed Jul. 30, 2007, U.S. patent application Ser. No. 11/131,647 filed May 18, 2005 and published as United States Patent Publication Number 2007/0182812, U.S. patent application Ser. No. 11/354,779 filed Feb. 15, 2006 and published as United States Patent Publication No. 2007/0002131, U.S. patent application Ser. No. 11/625,208 filed Jan. 19, 2007, U.S. patent application Ser. No. 11/829,696 filed Jul. 27, 2007, Ser. No. 11/432,647 filed May 11, 2006 and U.S. patent application Ser. No. 11/464,736, U.S. patent application Ser. No. 11/432,568 entitled “Volumetric Panoramic Sensor Systems” filed May 11, 2006; all filed on the present inventors behalf by Frank. C. Nicholas, Cardinal Law Group, 1603 Orrington, Suite 2000, Evanston, Ill. 60201, Ph. (847) 905-7111. The above applications art all of which in their entireities are hereby incorporated by reference as within the scope of the present invention.

### SUMMARY OF INVENTION

The present invention provides a novel adapter with substantially spherical panoramic audio-visual coverage that attaches to a conventional camera. The adapter requires special image processing, communication, associated control devices, mounting arrangements, optical and audio arrangements, and viewing display devices which are embodied within the present invention.

### BACKGROUND OF THE INVENTION

An advantage of spherical field-of-view panoramic photography, videography, and 3-D imaging is that an entire surrounding scene is recorded about a point in space with nothing being missed as compared to using current conventional cameras with limited field-of-view coverage. Up until the present invention, the ability of an ordinary person to record spherical FOV content has been limited because of cost, lack of enabling technologies, and design limitations of current cameras.

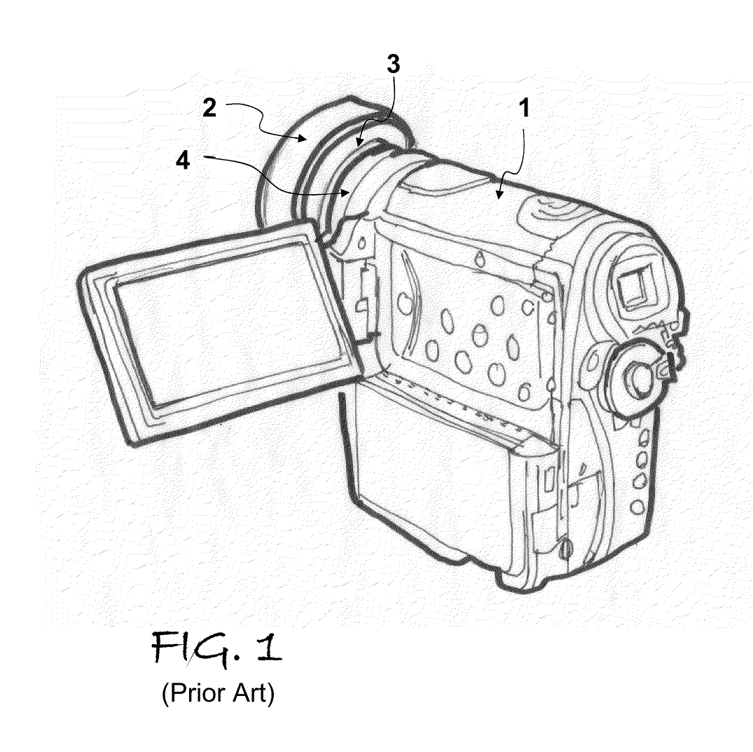

FIG. 1 shows a video camcorder 1 with a wide FOV lens 2, typically a fisheye lens, that is used to take a panoramic still or video images. Typically today, in order to record a spherical field-of-view (FOV) scene a single camera is rotated on a tripod to record an entire spherical FOV scene. However, a problem with this method is that the camera typically has a limited, less than 180 degree FOV, so only a portion of the scene can be recorded at any one time. And because subjects in the scene have moved subjects that are stitched together do not match when the computer performs image processing to stitch the recorded images together. This causes the scene to lack panoramic continuity.

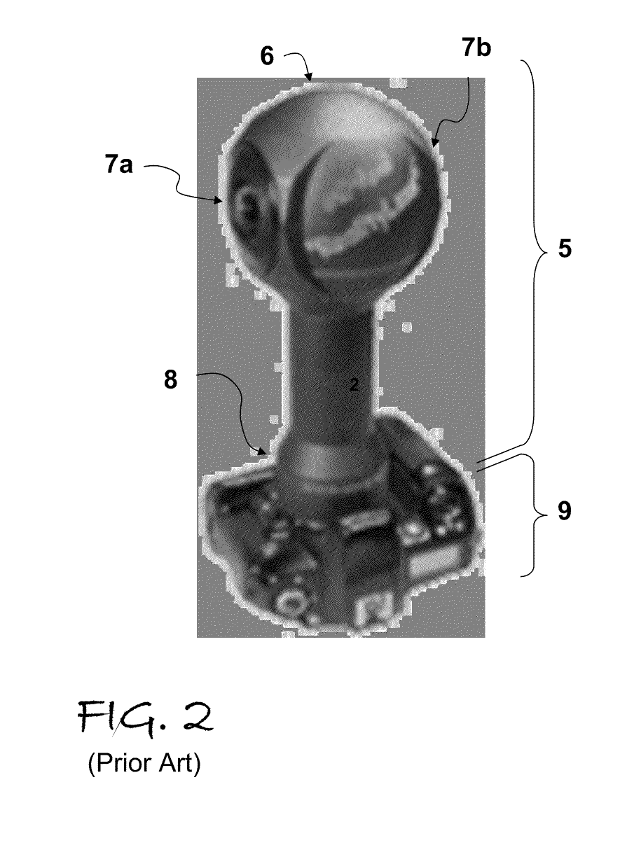

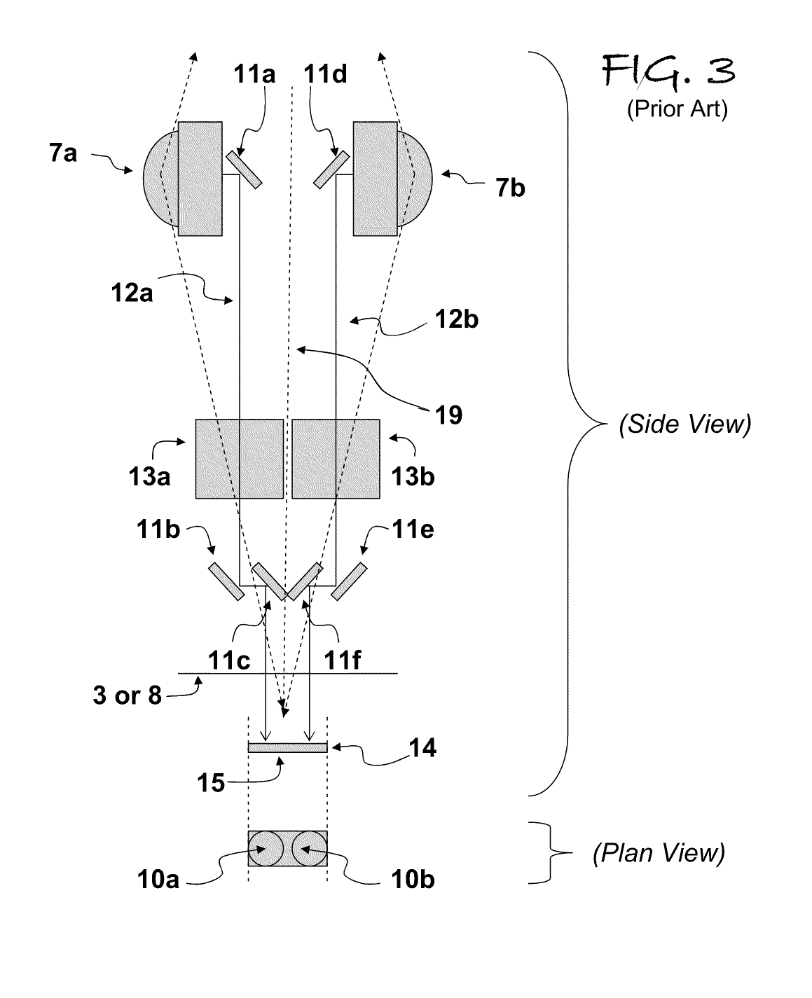

In disclosure documents filed in the 1980's with the PTO and in the 1987 U.S. Pat. No. 4,656,506 by Ritchey a panoramic camera system comprising a plurality of 6 cameras with adjacent fields-of-view facing outward that cooperatively recorded a composite scene having spherical field-of-view (FOV) coverage was disclosed. Then June 1991 U.S. Pat. No. 5,023,725 by McCutchen received a patent for a dodecahedral camera arrangement that expanded upon the concept of integrating a plurality of cameras together to record a spherical FOV scene. Additionally, in an alternative spherical FOV camera arrangement 6, disclosure documents dated in the mid-1980's and in U.S. Pat. No. 795,130,794 by Ritchey disclose a camera system for recording spherical FOV panoramic still or video onto a single frame. As shown in FIG. 2, a prior art spherical FOV lens 5, like that previously sold by Virtual Video Reality, Limited Liability Company of Leavenworth, Kans. as “RealityLens”™ which reflect the '794 panoramic lens design require the removal of a camera's 9 conventional lens and the incorporation of the tailored spherical FOV lens system 5 in order to achieve spherical FOV coverage. The diagram of the spherical FOV adapter lens in FIG. 3 generally illustrates the functionality and schema of this prior art. Additional mirrors, relay optics to project the image to the cameras sensor, and more sophisticated alignment are required to make this prior art arrangement work compared to the present invention. Currently only cameras with interchangeable lenses work for mounting the prior art spherical panoramic lens, unless the camera is built from the ground up with the panoramic lens integrated in the initial design. Today interchangeable lens mounts typically require a conventional screw or bayonet mount to connect this prior art spherical panoramic lens to the camera body. However, many people do not have cameras with removable interchangeable lens mounts, which limits their ability to use this type of panoramic lenses.

Still referring to FIGS. 2 and 3, previously offered spherical lens systems, sold as “RealityLens” by Virtual Video Reality (VVR), LLC incorporates two back-to-back optical systems which record two adjacent and corresponding hemispherical images. The camera 9 requires an interchangeable lens mount 8 typically comprising a bayonet or screw mount in order to mount the spherical lens system 5. Each optical path 12a and 12b consist of an objective lens that is a fisheye lens 7a and 7b of greater than 180 degrees FOV coverage, off axis transmission optics 11a, 11b, 11c, 11d, 11e, 11f such as prisms, mirrors, or fiber optic image conduits, and relay lenses 13a and 13b for focusing the image transmitted from the objective lens 7 to a portion of the image sensor of the camera 9. The optics that transmit the two hemispherical images 10a and 10b to the camera sensor require precise alignment and often require extra optical means which add to the cost of the assembly. Both the relay lenses and extra relay optics are required to transmit the images to the camera's sensor 15. The extra relay optics and relay lens means and precise positioning requirements add cost and make manufacture a limitation of this prior art. For the above reasons having to use a camera 9 that requires an interchangeable lens in order to mount a spherical FOV lens is a limitation.

Today the vast majority of consumer cameras 1, and even many prosumer cameras, have their objective and relay lens systems built into the camera and do not have interchangeable lenses.

Not being able to mount a spherical FOV lens onto a typical consumer cameras and camcorders with integrated objective and relay lenses is a problem for the typical consumer who wants to record spherical FOV audio-visual content.

Additionally, an affordable easy to use panoramic adapter 100 with substantially spherical field-of-view coverage compatible with existing cameras, computers, display, telecommunication, and weapon systems like the one disclosed in herein has not been provided in prior art. For instance, a unique remote wireless remote control unit with special software or firmware has not been developed for cameras with panoramic adapters such as the one disclosed herein. Additionally, a panoramic target acquisition system that allows an operator to look around the outside of a vehicle he or she is inside in at the panoramic scene about the vehicle using an adapter such as the one presented in the present application has not been disclosed in prior art. Furthermore, the integration of the panoramic adapter for use with a head mounted display or surround audio visual room display or with a position sensing to assist in engaging targets or subjects in a more accurate and more rapid manner has heretofore not been disclosed. Additionally integration plurality of microphones into a panoramic adapter for recording one signal or more representing a panoramic environment has heretofore not been provided. Also, panoramic software or firmware integrated into camera with said adapter disclosed herein, remote wireless camera control device, and other devices has not been disclosed in prior art. And a panoramic adapter of the type disclosed here for recording text and graphic information while simultaneously recording panoramic imagery has not been provided in prior art. And finally, multiple methods of recording panoramic imagery using a panoramic adapter have not been disclosed. Specifically, passive methods which use electro-optics of relaying an individual or multiple images that comprise a panoramic scene to an image plane within the adapter such that a host camera can focus on the image plane and record those images has not been provided.

Additionally, methods of removing distortion from a barrel distorted image recorded by a panoramic adapter have not been heretofore disclosed. And reduction and enlargement means within a panoramic adapter to compensate and adjust the size of the image for recording has heretofore not been provided in prior art.

### OBJECT OF THE INVENTION

Given the limitations of the above prior art it is the object of the present invention to overcome the above mentioned limitations of the prior art. Generally, it is the object of the present invention to provide an adapter for a camera that facilitates the recording of audio-visual signatures representing substantially a spherical FOV scene. Additionally it is an object of the present invention to provide an ordinary person with the ability to record spherical FOV content using their conventional video camera with the subject adapter which overcomes previous cost, ease-of-use constraints, lack of enabling technology, and design limitations.

More specifically, it is an object of the present invention to overcome the limitation of having to rotate a camera to record a spherical FOV panoramic image. Furthermore it is an object of the present invention to overcome the limitations involved in using a plurality of cameras to capture a spherical panoramic image. This is because using more than one camera is typically more expensive than using a single camera. And plural camera systems require more parts and are technically more challenging to manufacture. This adds to the cost and makes them more difficult to operate and when processing the imagery. The average person can only afford one video camera and wants their camera to take standard still imagery, video, and do panoramic photography as an aside. The present invention facilitates using a single camera to overcome past limitations of having to use plural cameras to achieve these objectives.

Additionally, it is an object of the present invention to provide a substantially spherical panoramic adapter lens that mounts onto the majority of conventional cameras which have fixed lenses, and do not have interchangeable lens mounts. Therefore it is an object of the present invention to facilitate mounting the adapter on a still, film, or video cameras that has a built in objective and associated relay lenses. And it is an objective of the present invention to make the adapter such that it may be mounted in a conventional manner to existing cameras with a screw or bayonet mounting system. The panoramic spherical FOV adapter lens described in the present invention allows the majority of people which have cameras with built in objective and relay lens systems to conveniently attach the adapter of the present invention to their conventional video camcorder and instantly achieve spherical FOV imaging. By mounting the adapter onto their conventional cameras, the present invention provides a larger number of people the ability to use their conventional cameras for capturing standard photos and video, or additionally/alternatively to use conventional cameras for panoramic still photo, film, or video photography.

Finally, it is an objective of the present invention to provide special image processing, communication, associated control devices, mounting arrangements, optical and audio arrangements, and viewing display devices which are associated with and embodied within the present invention. Please see the drawings and detailed specification for a more complete description of the present invention.

FIG. 1: Perspective illustration of prior art conventional camcorder with a single fisheye adapter lens. (Prior Art)

FIG. 2: Photo of prior art embodiment of a spherical field of view camera which requires a camera with an interchangeable lens mount and panoramic lens assembly which includes a relay lens to focus the panoramic image on camera sensor. This prior art is not an adapter lens it is a fully interchangeable lens. (Prior Art)

FIG. 3: Interior cutaway diagram of prior art spherical field of view lens like that shown in FIG. 2. (Prior Art)

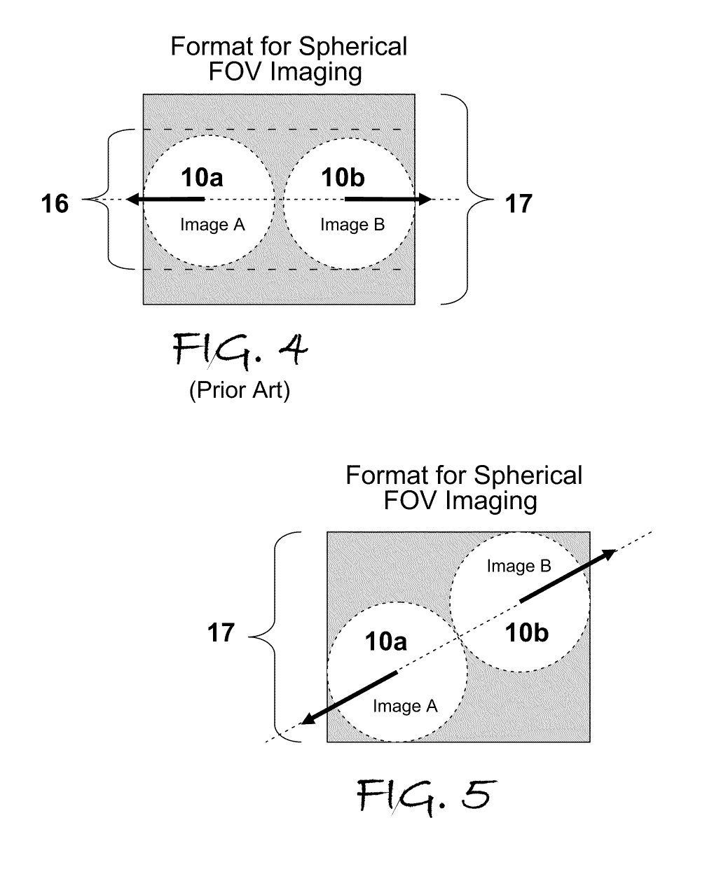

FIG. 4: 4:3 Format—Horizontally Aligned Images with subset 16:9 Format from Spherical FOV Camera.

FIG. 5: 4:3 Format—Diagonally Aligned Images from Panoramic Lens Adapter.

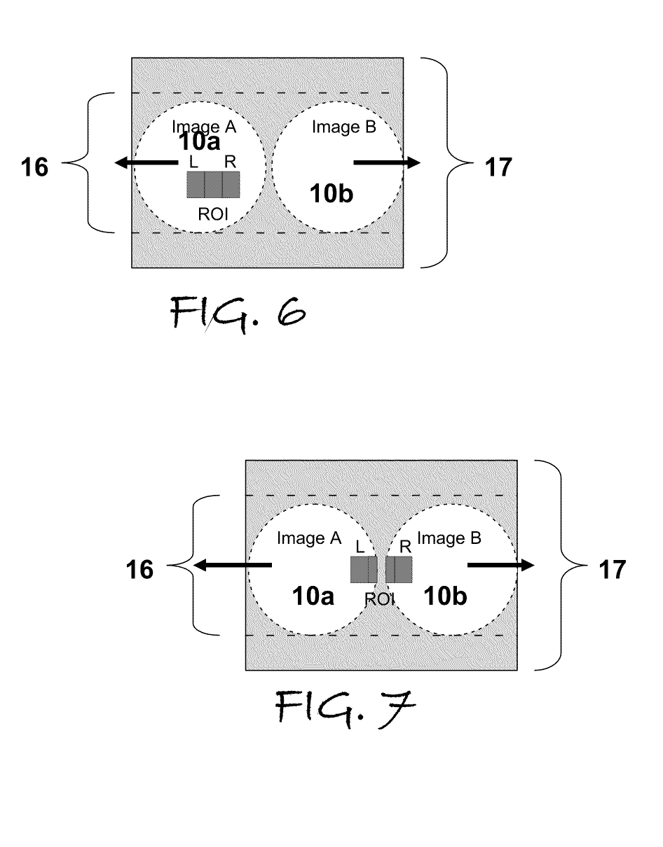

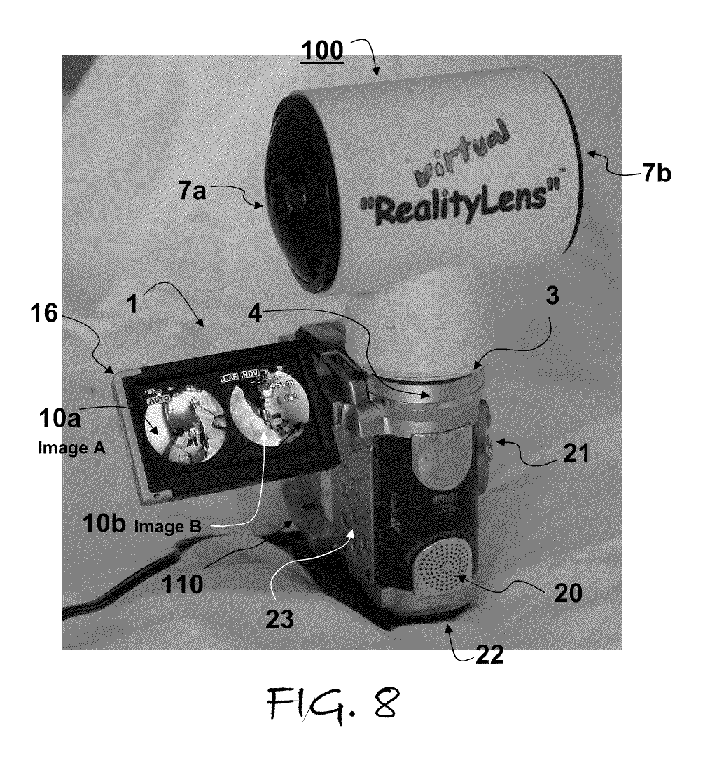

FIG. 6: 4:3 Format—Region-Of-Interest (ROI) in one hemi-spherically subset image. Horizontally Aligned Images with subset 16:9 Format from Panoramic Lens Adapter.

FIG. 7: 4:3 Format—Subset images in ROI in two hemi-spherically subset images horizontally aligned images with subset 16:9 format according to the present invention.

FIG. 8: Photograph of working prototype of the spherical FOV panoramic camera adapter lens mounted on a conventional Canon HV10 High Definition Video Camera with a 1920×1080 CMOS Sensor which comprises the preferred embodiment of the present invention. This adapter lens opens up spherical FOV video based virtual reality to the mass market. It overcomes prior art using a novel optical arrangement which allows mounting to standard cameras and camcorders with fixed lenses.

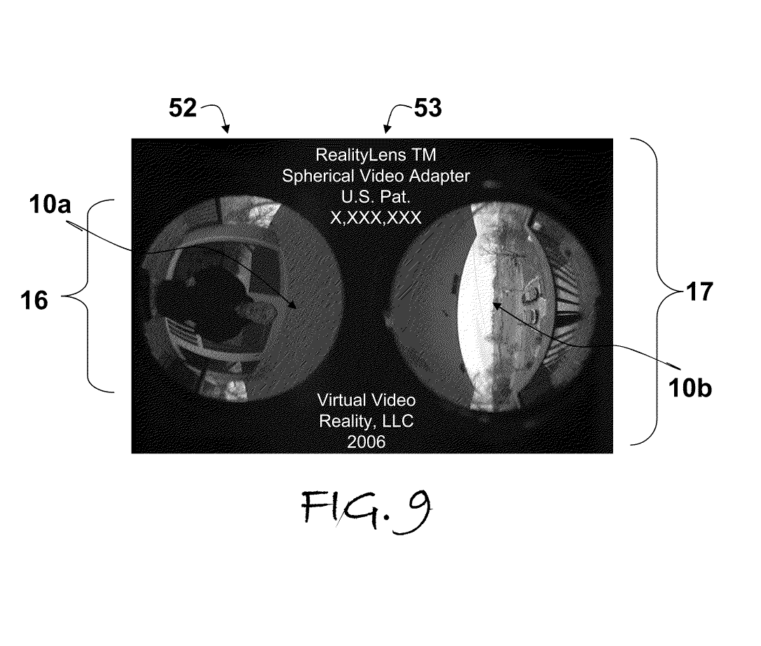

FIG. 9: Photograph of an example video frame resulting from preferred embodiment of the spherical FOV panoramic adapter lens disclosed in the present invention. Two back-to-back fisheye lenses and the associated optical system simultaneously transmit two barrel distorted hemispherical images to a single high definition video (HDV) camera which records the images. The above images are from a working prototype of the Spherical FOV Panoramic Camera Adapter Lens mounted on a conventional Canon HV10 High Definition Video Camera as illustrated in FIG. 8 and according to the preferred embodiment of the present invention.

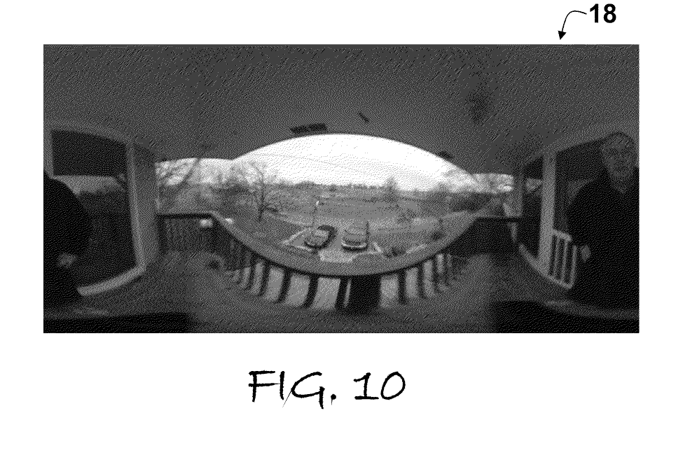

FIG. 10: Photograph of a computer processed image in which the barrel distortion of the images shown in FIG. 9 has been removed, the images have been rotated, translated, and inverted such that adjacent scene edges in the real-world scene match up, and the image has been stitched together to form a continuous scene. The computer image processing is accomplished in near-real time using a live video feed, or alternatively may be accomplished in post production. Interactive viewing software is used to pan and zoom around the dynamically changing spherical FOV motion-video scene.

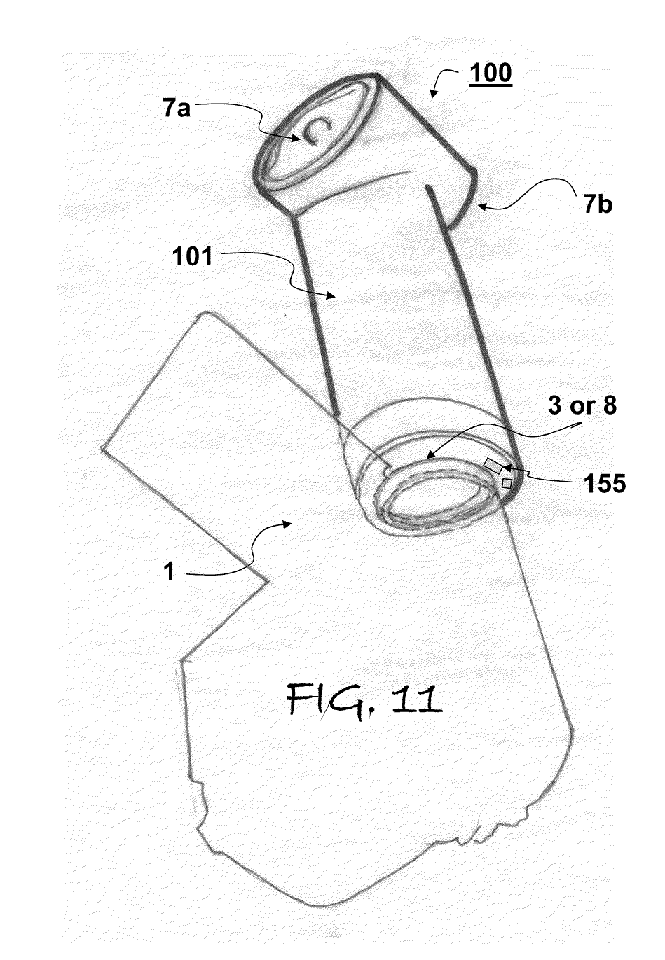

FIG. 11: Exterior Perspective of Panoramic Camera Lens Adapter with spherical field-of-view coverage.

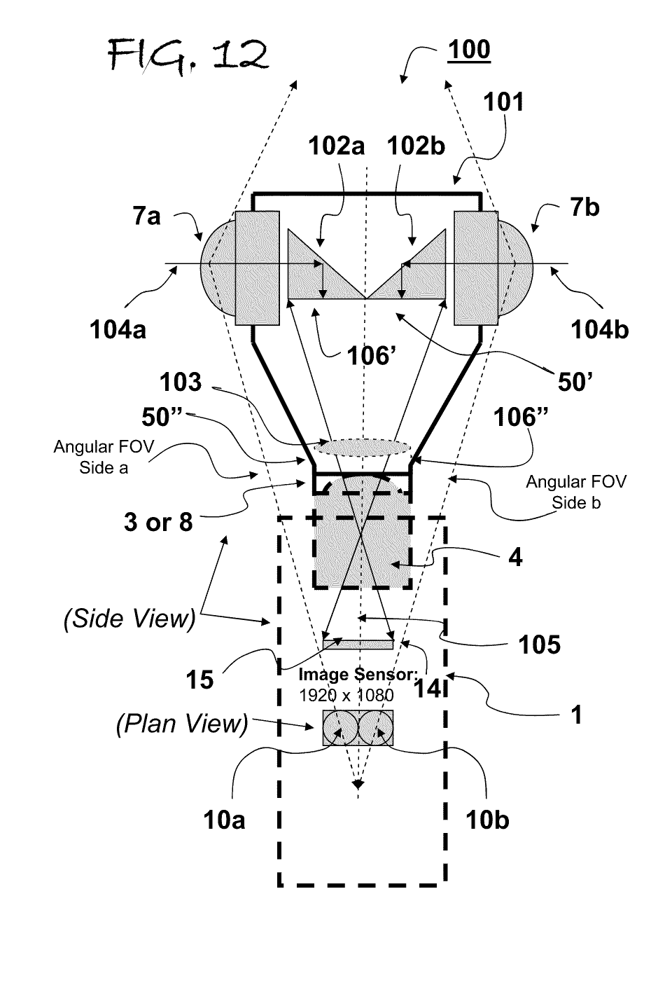

FIG. 12: Diagramatic illustration high-lighting the optical system of the present invention of a panoramic spherical FOV adapter lens. The present invention fits onto conventional camcorders with non-interchangable lens mounts.

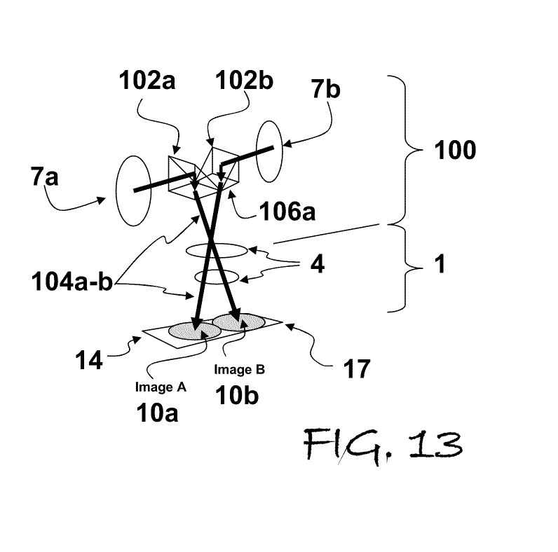

FIG. 13: Diagramatic cutaway perspective of the adapter lens optical system with spherical field-of-view coverage for recording monocular and binocular spherical field-of-view panoramic images in which the optical system incorporates right-angled prisms.

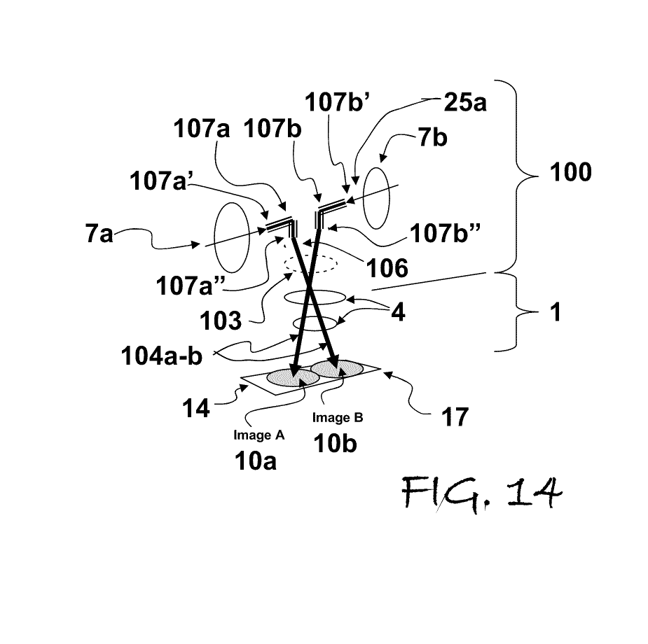

FIG. 14: Diagramatic cutaway perspective of the adapter lens optical system with spherical field-of-view coverage for recording monocular and binocular spherical field-of-view panoramic images in which the optical system incorporates fiber-optic image conduits.

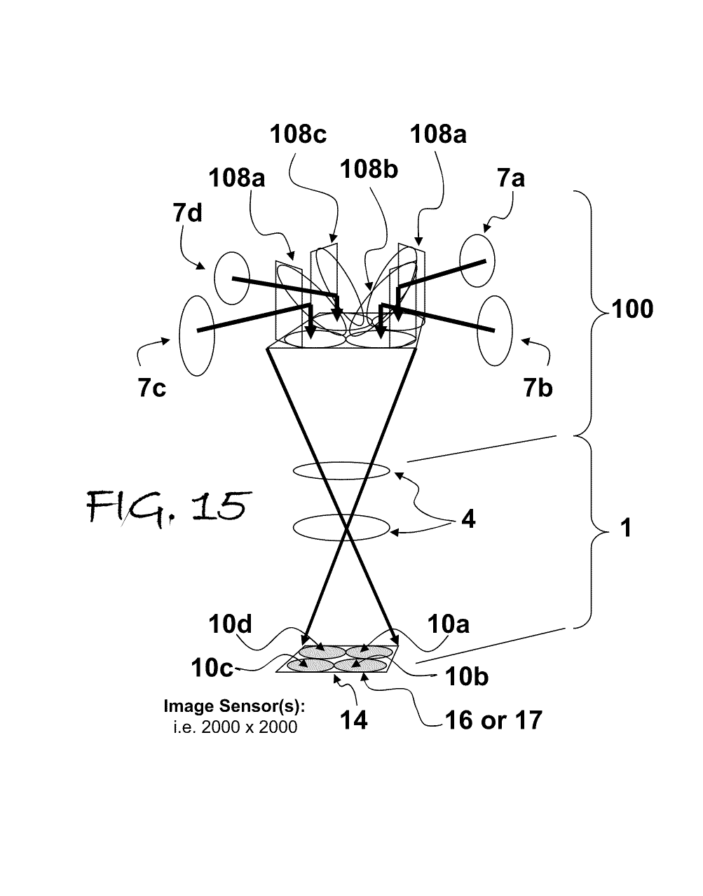

FIG. 15: Diagramatic cutaway perspective of the adapter lens optical system with spherical field-of-view coverage for recording stereoscopic spherical field-of-view panoramic images in which the optical system incorporates right-angled prisms.

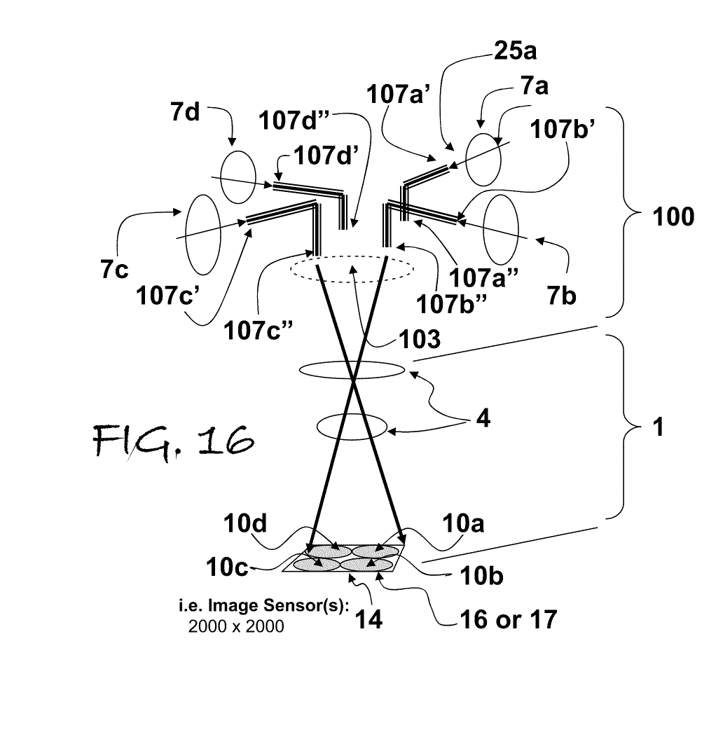

FIG. 16: Diagramatic cutaway perspective of the adapter lens optical system with spherical field-of-view coverage for recording stereoscopic spherical field-of-view panoramic images in which the optical system incorporates fiber-optic image conduits.

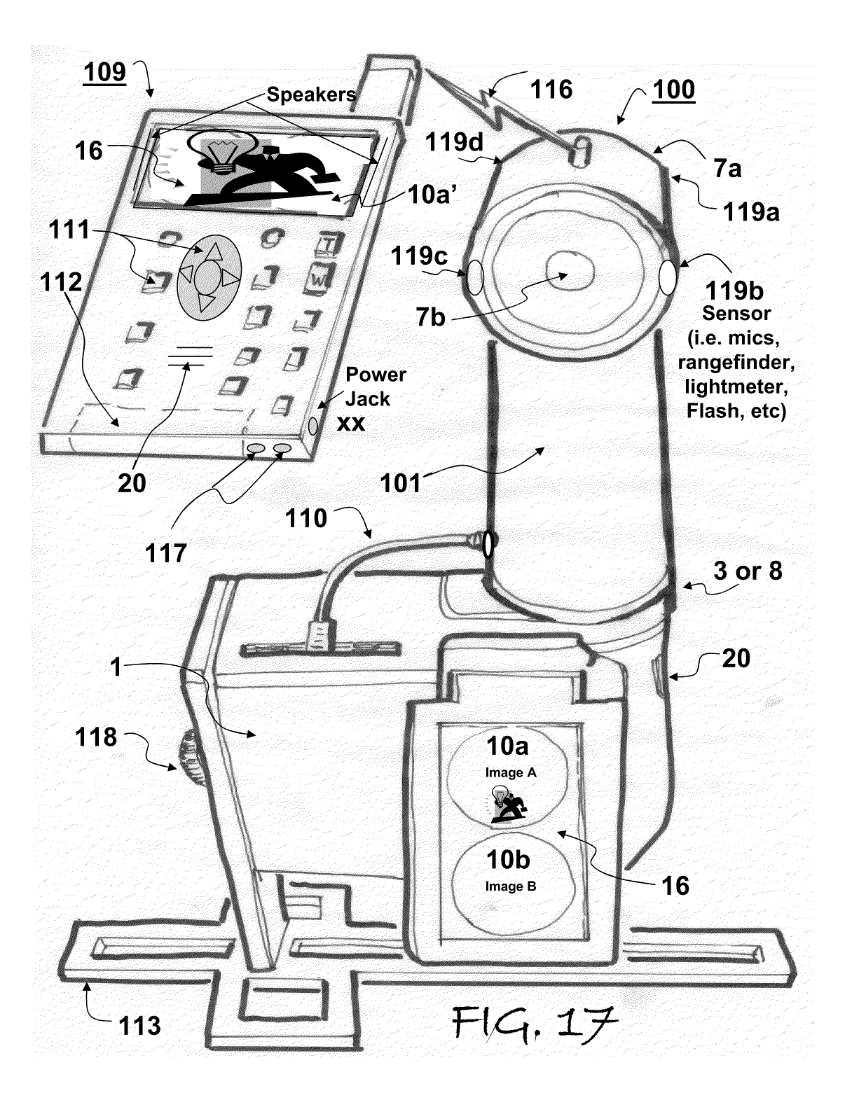

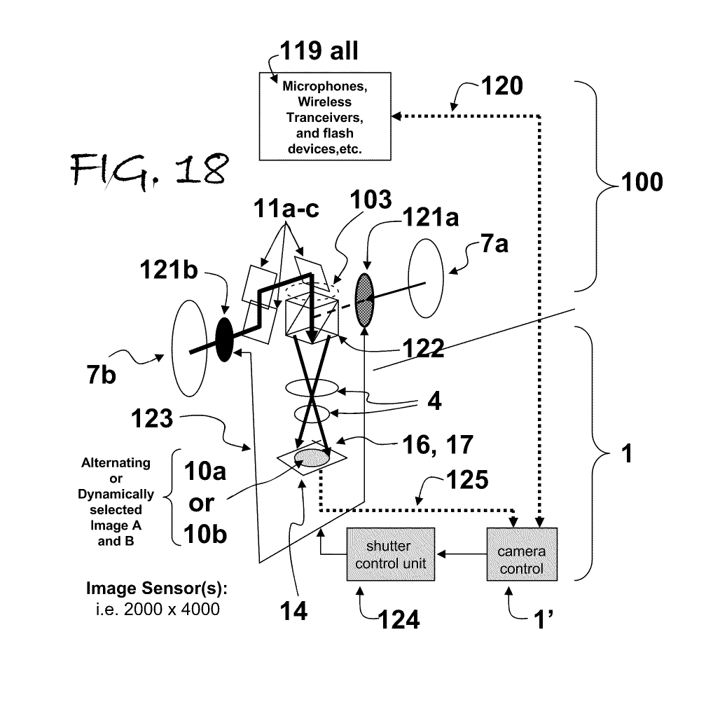

FIG. 17: Exterior perspective of the adapter lens system and associated remote control system with spherical field-of-view coverage.

FIG. 18: Diagramatic cutaway perspective of the adapter lens optical system with spherical field-of-view coverage in which the optical system which incorporates a cube beam splitter and mechanical or electro-optical shutter system that facilitates selected monoscopic or binocular frame multiplexed images to be recorded by an associated camera.

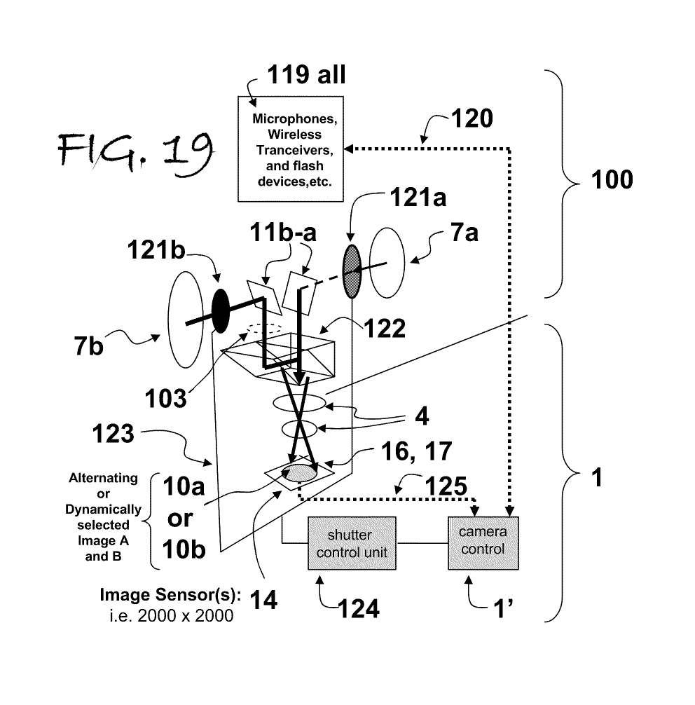

FIG. 19: Diagramatic cutaway perspective of the adapter lens optical system with spherical field-of-view coverage in which the optical system which incorporates a lateral displacement beam splitter and mechanical or electro-optical shutter system that facilitates selected monoscopic or binocular frame multiplexed images to be recorded by an associated camera.

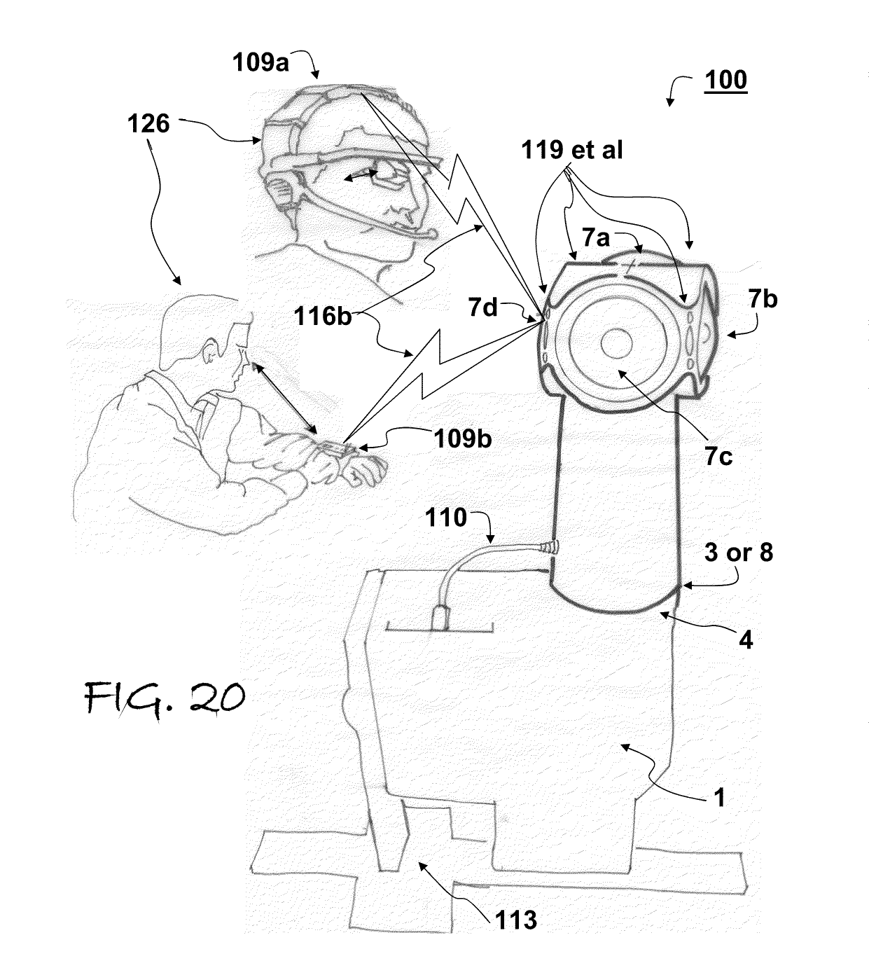

FIG. 20: Exterior perspective of the adapter lens system for recording stereoscopic spherical field-of-view images and an associated remote control system.

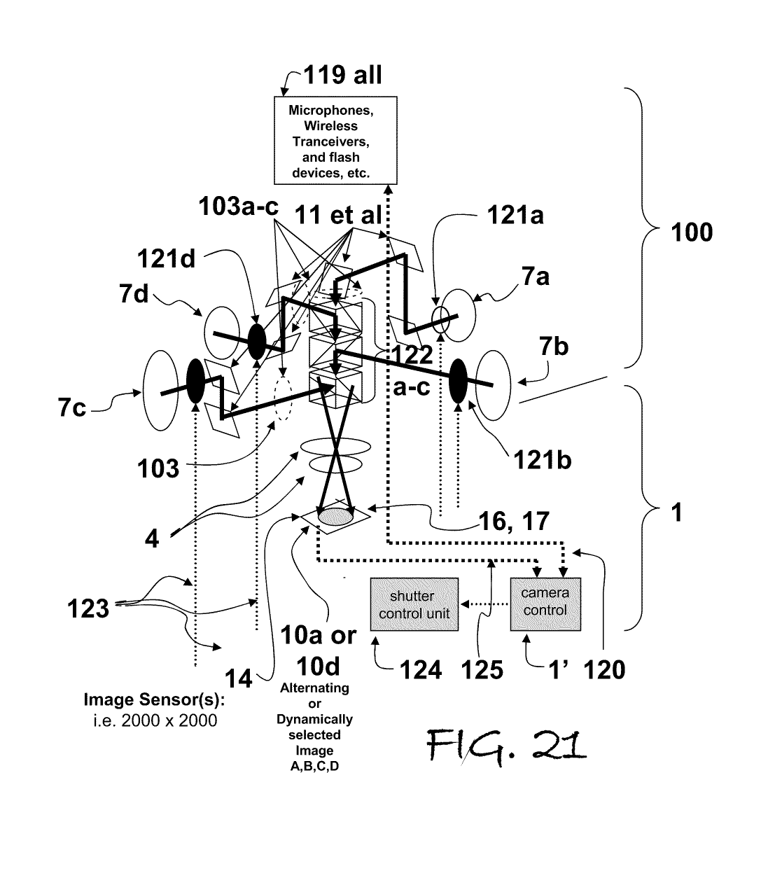

FIG. 21: Diagramatic cutaway perspective of the panoramic adapter optical system with spherical field-of-view coverage in which the optical system incorporates a mechanical or electro-optical shutter system that facilitates dynamic selection of a single image at a time being selected for recording by an associated camera.

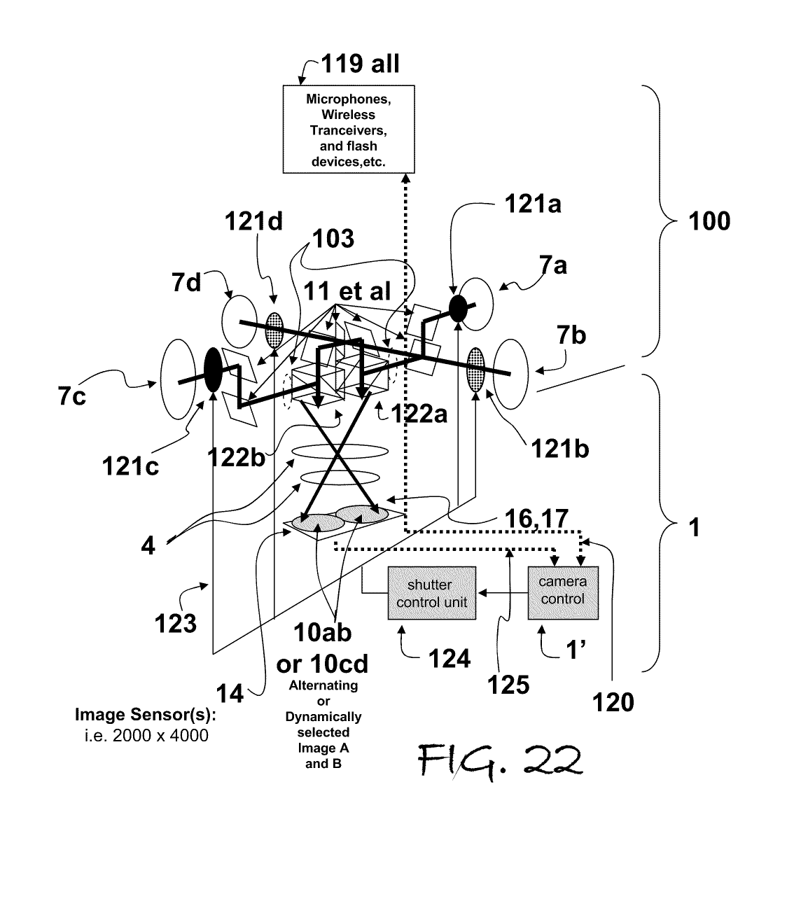

FIG. 22: Diagramatic cutaway perspective of the panoramic adapter optical system with spherical field-of-view coverage in which the optical system incorporates a mechanical or electro-optical shutter system that facilitates selected stereoscopic frame multiplexed images being recorded by an associated camera.

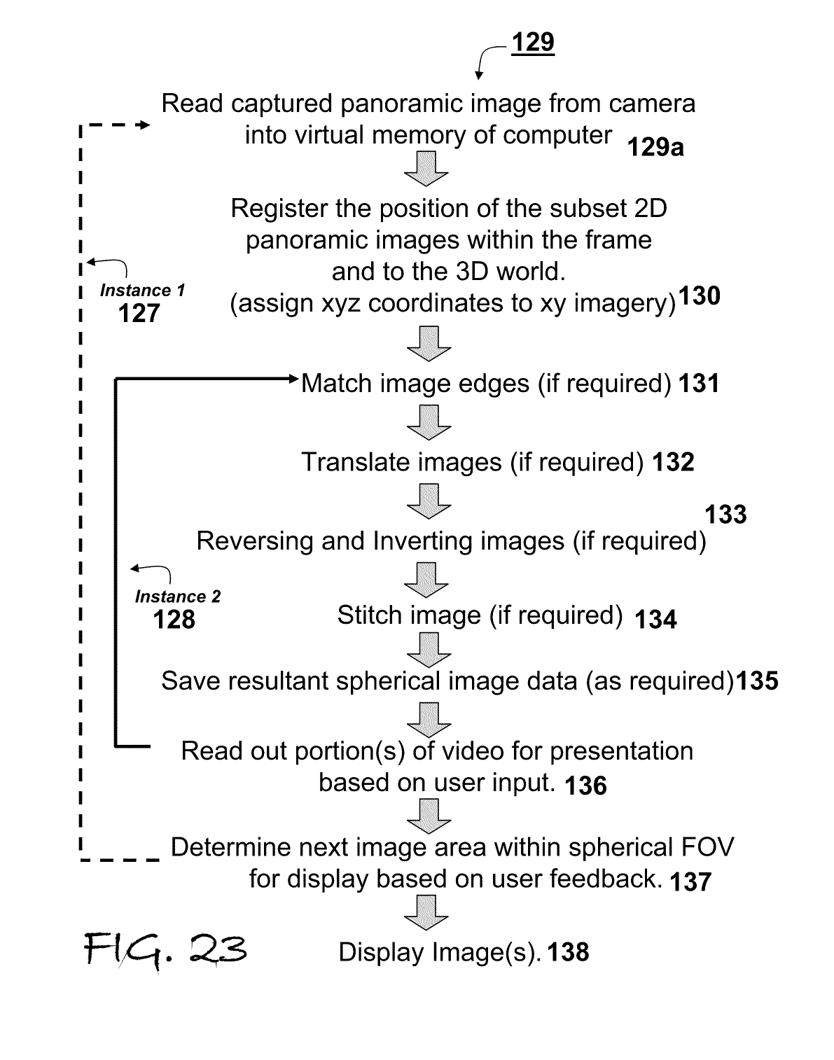

FIG. 23: Process and method diagram which describes manipulating images derived from the panoramic adapter according to the present invention. The process is realized in software and firmware used to manipulate said images derived from adapter using computer processing means.

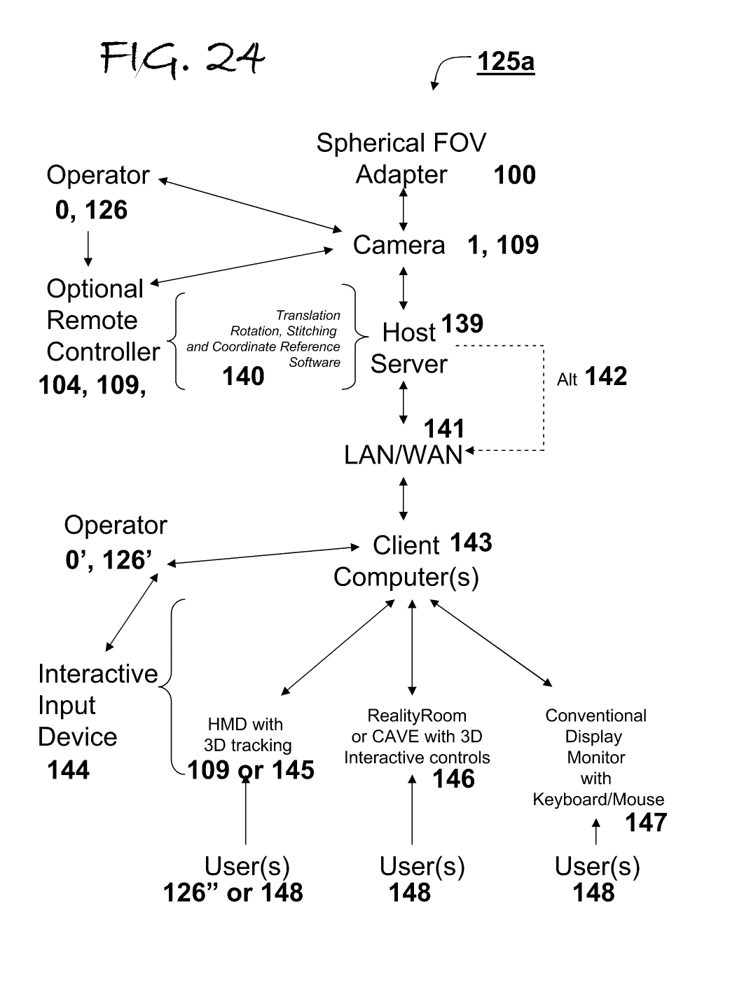

FIG. 24: System/Network architecture chart illustrating hardware and hardware connectivity used in recording, processing, and displaying imagery recorded by a camera with panoramic adapter according to the present invention.

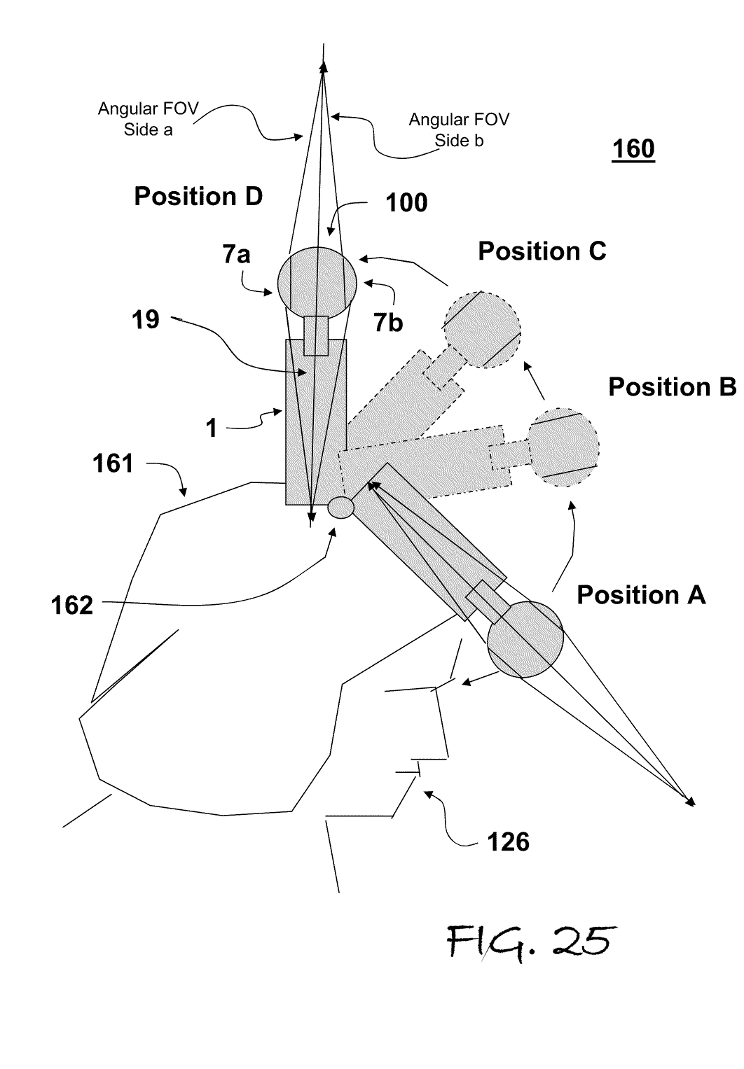

FIG. 25: A diagram of the side of a camera with the panoramic adapter mounted on a helmet that is may be positioned to achieve various views.

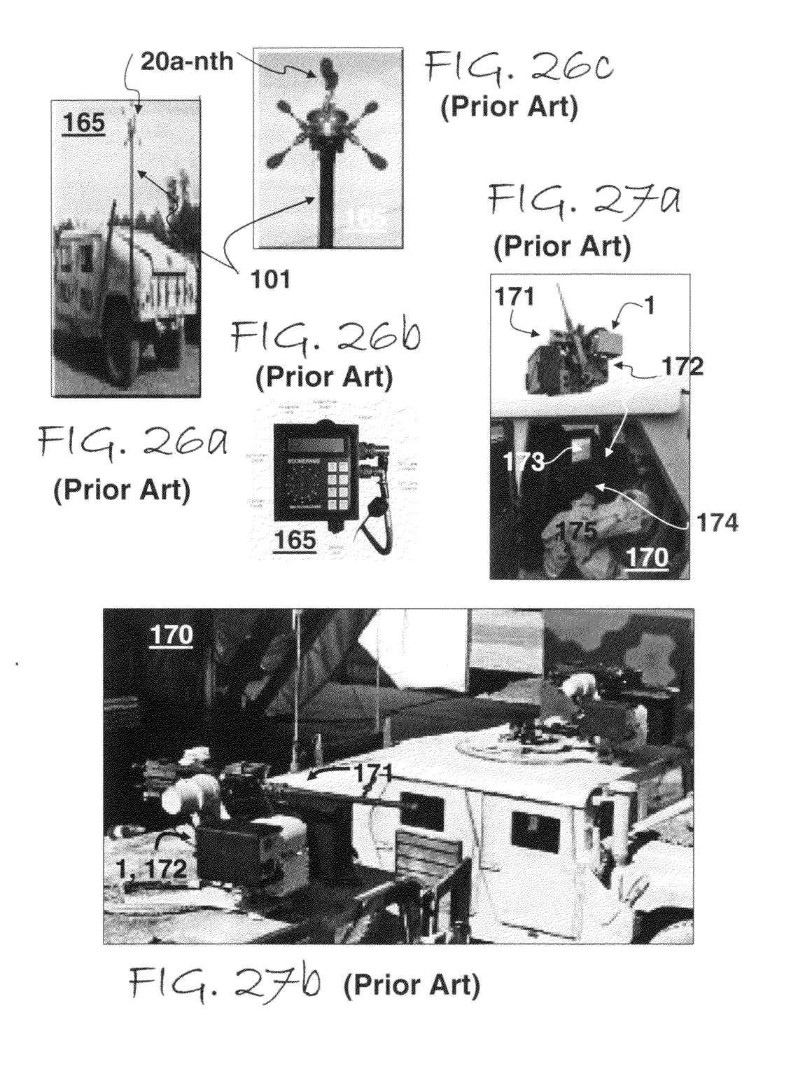

FIG. 26a: A photograph of a prior art “Boomerang” acoustical system designed to detect relative azimuth, range and elevation of incoming small arms fire that is incorporated and integrated with the panoramic adapter system of the present invention.

FIG. 26b: FIG. 26a: A photograph of a close-up of the mast and microphone portion of the prior art “Boomerang” system.

FIG. 26c: A photograph of a close-up of the interactive display portion of the prior art “Boomerang” system.

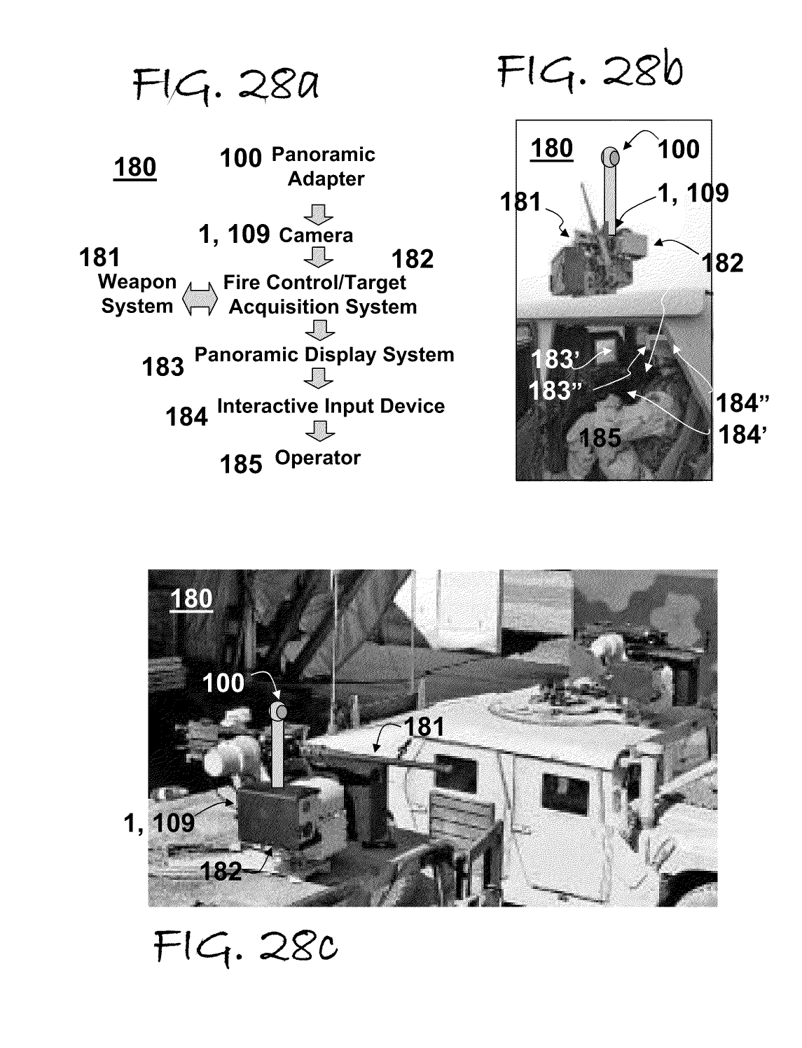

FIG. 27a: A photograph illustrating the prior art Common Remotely Operated Weapon Station (CROWS) System.

FIG. 27b: A photograph further illustrating the prior art Common Remotely Operated Weapon Station (CROWS) System.

FIG. 28a: A System/Network Architecture chart illustrating how the panoramic adapter system is integrated with the Common Remotely Operated Weapon Station (CROWS).

FIG. 28b: A photograph illustrating the illustrating how the panoramic adapter system is integrated with the Common Remotely Operated Weapon Station (CROWS).

FIG. 28c: A photograph further illustrating how the panoramic adapter system is integrated with the Common Remotely Operated Weapon Station (CROWS).

### DETAILED DESCRIPTION

FIG. 8 is a photograph of working prototype of the Panoramic Lens Adapter System 100 with Spherical Field-Of-View (FOV) coverage mounted on a conventional video camcorder 1 according to the present invention. It is foreseen by the present inventor that the adapter could be mounted onto the screw 3 or bayonet 8 mount of a interchangeable lens, but that is not the preferred embodiment of the present invention. In the present example the adapter is mounted to a Canon HV10 High Definition Video Camcorder with a 1920×1080 CMOS Sensor. The adapter lens opens up spherical FOV video based virtual reality applications to the mass market. It overcomes prior art using a novel optical arrangement which allows mounting to standard cameras and camcorders 1 with fixed lenses. FIG. 11 is an exterior perspective drawing which illustrates how and where the 37 mm adapter lens screw mounts 3 onto the camcorder. The camcorder includes mounting threads located on the exterior of the camera adjacent to the camcorders objective lens 4. The threads are typically used to mount filters, wide-angle, and telephoto lenses in front of the objective lens of the camcorder. While screw mounts are most common, the adapter lens can also be mounted using other methods, such as a bayonet mount 8.

The diagram of the spherical FOV adapter lens 100 in FIG. 12 generally illustrates the functionality and internal workings of the present invention. And illustrates how the present invention fits onto conventional camcorders 1 with non-interchangeable lens mounts. In operation the person operating the camera mounts the adapter 100 onto the camera 1. This is typically done by screwing the male threads on the adapter assembly into the female mounting threads of the camera and adjacent to the objective lens of the camera. The adapter is mounted firmly onto the camera to avoid damage that could be caused if the adapter comes off accidentally, to avoid unnecessary movement of the images being transmitted from the adapter to the camera, and to insure proper alignment of the camera to the adapter. It is also disclosed that conventional locking screws or other similar conventional locking means (not shown) can be incorporated to hold the adapter 100 in a manner that precludes the adapter from rotating past a desired position when mounted onto a camera or camcorder 1.

Still referring to FIG. 12 the adapter includes objective lenses consisting of two fisheye lenses 7a and 7b. Alternatively, persons skilled in the art will realize more than two objective lenses could be incorporated into the present invention without deviating from the intent of the present invention. The plurality of lenses could be of narrower FOV's, as long as enough lenses were incorporated to achieve an adjacent panoramic scene. The adapter 100 is attached adjacent to the conventional cameras 1 optical system 4 in a communicating relationship such that the conventional camera records the plurality of images which are apparent on the imaging plane 15 of the camera 1. The off-axis optical means transmits the images 10a and 10b onto the same imaging plane 15. In the present example the two fisheye lenses 7a and 7b transmit two hemispherical images 10a and 10b representing greater than 180 degree field-of-view coverage to the optical plane 15. Objective lenses 7a and 7b are situated facing outward from a central point in-order to record subset image 10a and 10b that can later be stitched together in a computer using image processing to achieve substantially spherical FOV coverage. Objective fisheye lenses 7a and 7b optically collect the subjects in their respective FOV of the images 10a and 10b surrounding the lenses. The respective images are then reflected and refracted by the respective mirrored prisms 102a and 102b to the respective focal planes 50a and 50b of the prisms.

Fisheye lens systems incorporated may or may not include relay lens elements depending on the design of the optical system. In the instance shown no relay lens is positioned directly behind the objective lenses 10a and 10b of the fisheyes. In fact in building the prototype adapter 100 shown in FIG. 8 the relay lenses of the fisheye lenses were removed. The advantage of not using the relay lens between the objective lens and mirrored prisms is that it reduces the need for extra components and makes the design more compact. Another advantage of this design is that it makes the overlapping image coverage of the two hemispherical images 10a and 10b recorded by the two fisheye lenses FOV coverage closer to the adapter 100. Still another advantage of not incorporating the relay lens in the adapter 100 is that it reduces the need for extra components and makes the optical design simpler. The reason the relay is not necessary in this novel and preferred optical design is because adapter 100 relies on the cameras optical system 4 to focus and relay the image to the image plane 15 of the camera 1. Fisheye objective lenses with approximately 185 degree FOV of a type that are preferably integrated into the present invention include the IPIX FIT Adapter Lens formerly sold by Internet Pictures, Inc. of Knocksville, Tenn.; Coastal Fisheye sold by Coastal Optics, Inc. of West Palm Beach, Fla.; Olympus adapter lens by Olympus Inc., Tokyo, JP; FC-E8 and FC-E9 Fisheye Lens by Nikon Inc. of Toyko, JP; Raynox DCR-CF 185 degree Pro fisheye lens of Toyko, JP; Miniature Megapixel Fisheye Lens DSL215 by Sunex of Carlsbad, Calif.; or a fisheye micro-lens for borescopes, endoscopes, and fiberscopes manufactured by AEI North America of Skaneateles, N.Y.

Alternatively, a conventional objective lens system that includes an objective lens and relay lens means may be incorporated into the design of the system without departing from the spirit of the invention. In such an instance, the relay lens (not shown) may be part of the objective lens 10a and 10b and transmit a focused image to the mirrored prisms 102a and 102b which have a common adjacent focal plane 50. In this instance a relay lens is positioned between the objective lens and mirrored prisms. This yields a less compact design which causes the adjacent FOV coverage to be further out from the adapter. However, if the optical components of the objective lens are small this may not be a significant limitation. The advantage of using a fisheye lens system that includes a relay lens component or components is that the image from the relay lens can be used to precisely focus the images at any distance. The distance may be on, within, or beyond the mirrored prisms, depending on the specific design of the lens adapter.

It should be noted that the optical design of the adapter 100 may or may not include a relay lens means at any point in the optical path 104 a and 104b between an objective lens and the optic that presents the image for the camera 1 to focus upon without departing from the intent and art disclosed in the invention. However, in either of the cases described above in this specification the optics in the adapter 100 are designed to be compatible with the camera optics 4 of the camera 1 so that the camera's optics 4 can focus the images 10a and 10b at the proper size and location onto the image plane 15 of the image sensor 14 of the camera 1.

Positioning the objective lenses 10a and 10b, and prisms 102a and 102b, of the most compact size and as close to one another as possible allows adjacent FOV coverage closer to the camera. While right angled prisms are shown in the present example, various types of prisms and other relay optics arranged in various manners to achieve the desired and disclosed effect may be used without deviating from the spirit of the present invention. In the present example, right angle mirrored prisms are oriented to refract and reflect the images to the imaging plane 50.

Still referring to FIG. 12, in order for the camcorder focusing system to record a uniformly focused view of the images 10a and 10b it is important that the images be focused onto a focal plane 106′ or 106″ perpendicular to the recording cameras optical axes 104a and 104b. In this instance the focal plane the camera is focusing on is the exit side of the mirrored right angle prisms 102a and 102b. In contrast, if angled mirrors are placed at 45 degrees on the image path the conventional camera will focus at a single depth-of-field along the angled mirrors leaving other portions of the images imaged on the mirrors out of focus. The optical arrangements in the present invention overcome that limitation. For instance in the present example the camera focuses on the focal plane 106′ and 106″.

Still referring to FIG. 12, a unique feature of the present invention is that it lends itself to the panoramic adapter 100 having the ability to recording text and graphic information 50′ or 50″ while simultaneously recording panoramic imagery. Graphic information 50′ or 50″ may be painted, etched, or printed onto a piece of material or onto the optics which is placed in substantially the same focal plane 106′ or 106″ that the image is presented. Now referring to FIG. The focal plane 106′ or 106″ will typically be in the same focal plane as the apparent images 10a and 10b are presented on the fiber optics 107a-nth, magnifier or de-magnifiers 103a-nth, or prisms 102a-nth, or objective lens 7a-nth to the camera for focusing and recording. Typically that is and needs to be within the same focal plane as where the graphic information 50′ and 50″ is presented. Because the graphics and image are in the same focal plane the camera 1 focuses on the presented image and graphics during recording of the image 10a or 10b simultaneously. The graphics may be placed on an optical stop. The stop will typically be of a thin material, or painted on the optic. The stop may be opaque except for the graphics area which is transparent so that the graphics show up when an image in the adapter is recorded. Or alternatively, the stop may be a dark color and the graphics a light color or visa versa so the graphics show up when the imagery is recorded by the camera. Still alternatively, the graphics can also be imaged or etched into the optical surface that the camera is focusing upon. The usefulness of this is that Trademark, Copyright, Identification number, or other information may be placed so that it must be recorded whenever imagery is recorded by the camera 1 with adapter 100.

The adapter 100 includes a mounting system, typically a screw 3 or bayonet 8 mount, for attaching the adapter to the camera 1. The adapter also includes an opaque housing 101, typically made of plastic or metal. The housing 101 keeps unwanted exterior light out of the interior of the adapter system and holds the optics and lens mount in place. Optical components in the housing 101 are secured by the housing, brackets, screws, glue, and other conventional means (not shown).

In the present example depicted in FIG. 12 the adapter 100 includes objective lenses consisting of two fisheye lenses 104a and 104b. The exit end of the adapter 100 is attached adjacent to exterior of the optical system 4 of the conventional camera 1 in a communicating relationship such that the conventional camera records the plurality of images which are apparent on the imaging focal plane 106′ or 106″ of the adapter. The off-axis optical means of prism 102a or 102b transmits the images 10a and 10b onto the same image/focal plane 15 or sensor 14 of the camera 1. In the present example the two fisheye lenses 10a and 10b transmit two hemispherical images representing greater than 180 degree field-of-view (FOV) coverage along the optical path/optical axis. Right angle prisms 102a and 102b are oriented to refract and reflect the images to the imaging/focal plane either 106′ or 106″.

In order for the focusing system of the camera 1 to record a focused view of the images 10a and 10b it is important that the images be focused onto an imaging focal plane perpendicular to the recording cameras optical axis 105. This overcomes a prior art limitation of the adapter 6 illustrated in FIG. 3 where flat front surface mirrors 11a and 11d are placed at 45 degree angles along the optical path 104a and 104b. If a similar mirroring system to that shown in FIG. 3 is used in the present adapter 100 shown in FIG. 12 the adapter 100 optics 4 of the conventional camera 1 focus at a single depth-of-field along the angled mirrors 11a and 11b rendering portions of the images imaged on the mirrors out of focus. To overcome this limitation the present adapter 100 shown in FIG. 12 incorporates optics 102a, 102b, and 103 that reflect and refract the images 10a and 10b to the front flat surface of the sensor 14 oriented perpendicular to the optical axis 105 of the optics 4 of the conventional camera 1. The optical arrangements in the present invention, which incorporate prisms 102, fiber optic image conduits 107, and/or optional magnifier 103 for presenting images on a single substantially flat focal plane overcomes and replaces the limitation caused when flat surface mirrors 11 angled at 45 degrees are incorporated as in prior art. However, it is important to note that flat surface mirrors 11a and 11b like that in FIG. 3 can be incorporated into the adapter 100 depicted in FIG. 12 if the images 10a and 10b are transmitted to the front surface of the enlargement magnifier 103 so that the camera 1 focuses on the essentially flat focal plane 50″ of the magnifier optic 103 and not some point along the angled mirrors 11a and 11b behind the magnifier 103 without departing from the spirit of the invention.

Optionally and still referring to FIG. 12, for a camera 1 with limited macro focusing capabilities, enlargement optics 103 may be incorporated that enlarge the two hemispherical images 10a and 10b. Standard magnification lenses 103, such as convex lenses are typically incorporated as magnifier lenses in adapter 100. Right angle prisms are oriented to refract and reflect the images to the imaging/focal plane 50″ of the magnifier lens 103. It should be noted that magnifiers 103 may be placed at any place along the optical path of the adapter 100 to increase the apparent size of the image 10a and 10b. The camera 1 focusing system is focused on the enlarged image 10a and 10b presented by the optical enlargement means 103. In this manner the hemispherical images 10a and 10b are enlarged such that they fill the frame format of camera 1 shown in either FIG. 4, FIG. 5, and as shown in FIG. 8. Still alternatively, fiber optic image conduits 107a or 107b that are tapered may incorporated to enlarge images 10a and 10b such that the camera 1 can focus on the images 10a and 10b. The incorporation of fiber optic image conduits will be described in additional detail when discussing FIG. 14 of this specification.

As illustrated in FIG. 11 the adapter 100 includes a mounting system, typically a screw mount 3 or bayonet mount 8, for attaching the adapter to the camera 1. The adapter 100 also includes an opaque housing 101 that keeps unwanted exterior light out of the interior of the adapter system and holds the optics and adapter mount 3 or 8 in place. The housing 101 is typically constructed of plastic or metal. Optical components in the housing are secured by the housing, brackets, screws, glue, and other conventional means and techniques well known in the optics industry.

FIG. 13 is a diagrammatic cutaway perspective of the adapter lens consistent with FIGS. 8 thru 12. Within the adapter 100 optical means along each optical path 104a and 104b consist of an objective lens 7, off axis transmission optics, such as prisms 102 with integrated mirrors or fiber optic image conduits 107. The adapter 100 in FIG. 13 is designed to facilitate composite spherical field-of-view coverage. The adapter is used for recording a subset of images for monocular and biocular spherical field-of-view panoramic images. The optical system incorporates right-angled prisms 102a and 102b. Resultant images from this embodiment of the camera are shown in FIGS. 4, 5 and 9.

FIG. 14 is a diagrammatic cutaway perspective of the Panoramic Lens Adapter System 100 for recording monocular and biocular spherical field-of-view panoramic images in which the optical system incorporates fiber-optic image conduits 107a and 107b. In FIG. 14 fiber optic image conduits 107a and 107b are used in place of prisms 102a and 102b shown in FIG. 13 to transmit the off-axis images to a common image/focal plane 50′ or 50″. The flat exit end of the fiber-optic image conduits 107a′ and 107b′ typically comprise the image focal plane 50′. Optionally, fiber optic image conduits 107a or 107b that are tapered may be incorporated. Enlarging the images 10a and 10b is required if the camera 100 does not have a macro focusing capability that allows it to focus down to the sized that the objective lens and relay optic is presenting the images. To enlarge images 10a and 10b such that the camera 1 can focus on the images 10a and 10b tapered fiber optic image conduits 107 may also be incorporated. Enlarging the images within the adapter 100 facilitates the images are recorded by a camera 1 with limited macro capability. Non-tapered and tapered fiber optic image conduits 107, either flexible or rigid may be incorporated. Tapered and non tapered fiber optic image conduits 107a or 107b of a sort that are used in the present invention are sold by Edmunds Scientific, Inc and Schott Optics, Inc. When fiber optic image conduits 107a and 107b are incorporated into the adapter 100 a relay lens 25 is placed between the objective lenses 7a and 7b and the entrance end of the fiber optic image conduit 107a′and 107b′. The relay lens 107a or 107b transmits the image from the objective lens 7a and 7b to entrance end of the fiber optic image conduits 107a′ and 107b′in focus. The image is then transmitted to the exit end of the fiber optic image conduits 107a″ and 107b″. Each of the fiber optic image conduits are gathered at the exit end 107a″ and 107b″. Alternatively, the entrance end of the fiber optic image conduit 107a′ and 107b′may be welded onto the objective lens 7a′ and 7b′ making a relay lens 25a and 25b unnecessary. The images displayed on the exit ends of the fiber optic image conduits 107a″ and 107b″ in the adapter 100 are then imaged by the camera 1. The fiber optic image conduits 107a and 107b may be oriented and placed next to one another such that a continuous image is rendered as shown in FIG. 10. Images displayed on the exit ends of the fiber optic image conduits may be presented as shown in FIG. 9. Additionally, barrel distortion caused by the objective lens 107a″ and 107b″ may be removed or reduced by using a special tapered fiber-optic image conduit arrangement popularly referred to as “FiberEye”™, Galileo Electro-Optics, Inc, and described in U.S. Pat. Nos. 4,099,833 and 4,202,599 by Tosswill in place of the conventional fiber optic image conduits 107a and 107b shown in FIG. 14.

As shown in FIGS. 15 and 16 spherical FOV panoramic adapter 100 embodiments of the present invention are provided that facilitate the stereoscopic recording of panoramic images 10a, 10b, 10c, and 10d that according to in the present invention. In the stereoscopic embodiments of the present invention objective lenses 7a, 7b, 7c, and 7d have overlapping and adjacent coverage such that at least two views of the surrounding subject/scene are recorded in an aggregate 360 degree FOV manner. Preferably very high resolution image sensors or film are used to record stereoscopic imagery in order to maintain good image resolution when the final image is presented to the viewer. A High Definition Camcorder of the type shown in FIG. 8 may be incorporated or camcorders with even higher-resolution image sensors like the Mysterium™ Super 35 mm cine sized (24.4.×13.7 mm) sensor which renders film-like 12,065,00 pixels per frame image resolution. The Mysterium sensor has a 12 mega-pixel image sensor that operates at 60 frames per second to record RAW, or 2× over-sampled High Definition Signal in a 4:4:4 or 4:2:2 digital video format. The sensor has greater than a 66 decibel Signal to Noise Ratio because it uses large 29 square micron pixels. In such an instance the stereoscopic adapter 100 is typically screw or bayonet mounted to the camera 1 as previously described. Alternatively, a camera of a type that may be incorporated is the Red One digital camcorder manufactured by the Red Digital Cinema Camera Company. The Red One incorporates the Mysterium sensor but uses an interchangeable lens. In such an instance the adapter 100 is typically mounted in front of the interchangeable lens that mounts to the Red One camcorder. The interchangeable lens is adjusted to focus in on the images 10a, 10b, 10c, and 10d presented in the adapter 100. Those skilled in the art will understand that various adapter 100, camera objective lens 4, to FIG. 16 is a diagrammatic cutaway perspective of the adapter 100 optical system with spherical field-of-view coverage for recording stereoscopic spherical field-of-view panoramic images in which the optical system incorporates fiber-optic image conduits 107a, 107b, 107c, and 107d. Optics are similar to that shown in FIG. 14, except that there are more of the same components placed in a similar configuration. Similar adapter 100 to camera 1 design configurations are possible without departing from the spirit of the present invention.

FIG. 15 is a diagrammatic cutaway perspective of the adapter 100 optical system with spherical field-of-view coverage for recording stereoscopic spherical field-of-view panoramic images in which the optical system incorporates right-angled prisms 108a, 108b, 108c, and 108d. Optics similar to that shown in FIG. 13 are incorporated into this embodiment of the adapter, only there are more of the same components placed in a similar configuration such that images 10a, 10b, 10c, and 10d are transmitted to the image sensor 14 simultaneously. This yields at least two views of any surrounding subject about the adapter 100 which facilitates the sampling out of stereo imagery for processing and display.

In operation the person operating the camera mounts the adapter 100 onto the camera 1. This is typically done by screwing the male threads on the adapter assembly into the female mounting threads of the camera and adjacent to the objective lens of the camera. The adapter is mounted firmly onto the camera to avoid damage that could be caused if the adapter comes off accidentally, to avoid unnecessary movement of the images being transmitted from the adapter to the camera, and to insure proper alignment of the camera to the adapter. It is also disclosed that conventional locking screws or other similar conventional locking means (not shown) can be incorporated to hold the adapter 100 in a manner that precludes the adapter from rotating past a desired position when mounted onto a camera or camcorder 1.

In operation to position the adapter in the correct orientation to fill the image frame the camera operator powers the video camera “ON” and looks at one of the cameras viewfinders. The operator puts the camera on the “PLAY” mode so that the camera operator can see two hemispherical images 10a and 10b on the large exterior viewfinder 16 so he or she can adjust the location and focus of the subject images 10a and 10b displayed by the camera 1. The adapter is screwed onto the camera such that images 10a and 10b fall within the imaging frame 17 of the camera 1 as depicted in FIG. 4 or 5. A camera 1 or sensor 14 with any format be incorporated without straying from the intent of the present invention. As required, the camera operator uses the cameras telephoto, also frequently called zoom capability, to maximize the size of the images 10a and 10b in the frame 17. The adapter 100 is typically mounted such that the images fall in a horizontal position parallel to the frame format shown in FIG. 4. In FIG. 4 the images 10a and 10b are maximized to fit within a 16:9 High-Definition Television frame format 16. In this example the 16:9 image format is read out of a sensor with a 4:3 image format potential. Alternatively, in order to optimize the coverage of the sensor with 4:3 frame format potential the adapter 100 is oriented on the camera 1 such that images 10a and 10b may be oriented in a diagonal manner like that shown in FIG. 5. If needed, and on some cameras, the cameras zoom lever is used to adjust the image so that the images fill the frame. The higher the resolution of the sensor and the more the images fill the frame the higher the resultant spherical panoramic scene that can be rendered. Typically, on a modern camera 1, such as the Canon HV10 and HV20 used in the present example, the automatic focus processing on the camera functions to sharply focus the two hemispherical images 10a and 10b presented in the adapter 100 once the user operating the camera zoom places the two hemispherical images within the camera's field-of-view. Once the images are in focus within the imaging frame of the camera the two hemispherical images are recorded by the camera by the operator activating the “RECORD” button on the camera. Alternatively, a camera 1 with an adapter 100 mounted to it may be operated by using the camera's conventional wireless remote control device (not shown) without departing from the spirit of the present invention. A conventional wireless control device or a computer to control a camera 1 with adapter 100 that can be used and is consistent invention is described and the operation explained in the Canon HV10 and HV20 Users Manual. Alternatively, a wireless control device like that described in the U.S. Patent Application Serial No. 20070182812 filed Aug. 9, 2007 entitled “Improved Panoramic Image-Based Virtual Reality/Telepresence Audio-Visual System and Method”; and U.S. Patent Application 20070002131 filed Jan. 4, 2007 entitled “Dynamic interactive region-of-interest panoramic/three dimensional immersive communication system and method” by the present inventor may also be used to operate the camera and adapter. Likewise the camera 1 with the adapter 100 mounted to it may be operated by using a standard computer with a USB, DVMI, or 1394 IEEE connection without departing from the spirit of the present invention.

Decreasing the movement of the hemispherical images 10a and 10b recorded on each frame 17 using a camera 1 with an adapter 100 is an important concern. Taking imagery using the adapter and associated camera mounted on a solid vibration free platform facilitates crisp clear image recording. However, this is not always possible. In those instances, using image stabilization hardware, firmware, and software as an embodiment to the present invention is especially important when taking handheld or vehicle mounted imagery with the adapter and an associated camera. Image stabilization capabilities within the camera are preferably used to lesson the movement on the frame of the recorded images. An example of image stabilization that may be incorporated within the present invention is described in the Canon HV10 and HV20 Users Manual and has been demonstrated in prototypes of the present invention as illustrated in FIG. 8. Besides activating image stabilization organic to the camera, image stabilization is also improved by mounting the camera 1 with adapter 100 on what are referred popularly to within the televison and video industry as SteadyCAM™, GlideCAM™, or FlyCAM™ to lesson the vibration that causes blurring of the recorded images 10a and 10b. Additionally, image stabilization may also be compensated for in post production by using image stabilization software.

Still referring to our present example, a camcorder 1 may have a limited telephoto zoom and wide angle (also called macro focus) capability. In such instances this precludes the camcorder from focusing in on and filling up the frame 17 with image 10a and 10b presented by prisms 102a and 102b or at the exit end of the fiber optic image conduits 107a″ and 107b″ focal plane 106′. To overcome this limitation magnifier optics 103 are incorporated such as double sided convex lenses and tapered fiber optic image conduits. In such instances magnifier optics 103 are placed on the optical path 104a and 104b between the adapter objective lenses 7a and 7b and the objective lens system 4 of the camcorder 1.

For instance, a 3× magnifier may be placed adjacent to the adapters lens mount to increase the image size such that the camera can zoom in on the image such that the entire 16:9 or 4:3 aspect ratio of the frame 17 is filled by the hemispherical images 10a and 10b to the maximum amount possible. A plurality of optical elements that serve as magnifier optics 103, such as convex lenses, are stacked along the optical path to increase the apparent image magnification to the extent necessary if desired by the optical designer. Convex lenses of a type that are incorporated into the present invention are sold by Edmunds Optics, Inc. of Barrington, N.J. or like the plastic lenses sold in magnifier lights by Great Point Light Inc. of Nantucket, Mass.

Alternatively tapered fiber optic image conduits 107a and 107b are incorporated to enlarge the image. In such an embodiment each objective lens 7a and 7b may transmit it's own respective image thru a respective relay lens to the entrance end of a respective fiber optic image conduit 107a and 107b which is tapered such that an enlarged image is displayed at the exit end of the fiber optic image conduit 107a″ and 107b″. In such an instance, the individual fiber optic conical tubes that make up the bundle are smaller at the entrance end 107a′and 107b′ and larger at the exit end of the fiber optic image conduits 107a″ and 107b″ such that the image transmitted through the fibers is enlarged by the time it reaches the exit end of the fibers. The fibers are arranged in a coherent manner such that the image transmitted onto the entrance end is the same coherent image exists at the exit end. The adjacent images 10a and 10b at the exit end of the fiber optic image conduit 107a″ and 107b″ are then imaged by the camcorder 1 and recorded. Alternatively or in addition too, a Fibereye™ design (cited above) of the fiber optic image conduits 107a and 107b may be incorporated to remove or reduce the barrel distortion caused by the fisheye lens 7a and 7b that constitute the objective lenses 7a and 7b of the adapter 1.

FIGS. 17-21 presents an alternative design of the adapter 100 which incorporates electronic and/or mechanical arrangements for performing various functions advantageous to recording spherical FOV audio-visual signals. Preferably electrical power for controlling the electronic and/or mechanical means within the adapter 1 is provided by the camera via a camera to adapter connector 110 as shown in FIG. 17. Alternatively, small batteries are placed in the adapter to power electronic or mechanical means in the adapter. The camera to adapter connector 110 will typically consist of a standard cable and connectors on each end of the cable, such as a USB, 1394 IEEE, or DVMI cable with compatible input and output jacks. The camera to adapter 110 connector functions to transmit and receive control signals between the adapter 100 and camera 1.

Still alternatively, in place of the exterior cable and connectors 110, contacts (not shown) are located on the adapter 100 and camera 1 mount 3 or 8 in a communicating relationship such that electrical current, control signals, or video signals are transmitted between the adapter 100 and camera 1. In such an instance the adapter 100 must be built with designated contacts that connect via wiring and circuitry to specific power, control, and video functions within the camera 1. Correspondingly, those designated contacts must match up to contacts, wiring, circuitry, and functions within the camera 1 and adapter 100. Typical devices 119 in the adapter will include audio microphone means, flash illumination means, camera and adapter control means, wireless camera to adapter transceiver means, and electrical power means. Control and video signals may be sent directly to and from the camera 1 or transmitted through the adapter 100. The use of metal contacts, wiring, circuitry, and processing to connect cameras, interchangeable lenses, filters, and adapters is well know in the camera industry and the use of such means in the present invention will be understandable to those skilled in the art.

FIGS. 17 and 20 are perspective drawings that illustrate several wireless remote control device 109 for operating and viewing audio-visual signals recorded by a camera 1 with a panoramic spherical FOV adapter 100. In the drawings the signals, antennas, and signal transmission means between the camera, adapter, and wireless remote control device is generally indicated by the number 116. And electronic sensors and emitters located in the head of the adapter are generally referred to as 119 all. A wireless control device 109 is an important addition to the spherical FOV adapter system because it allows the camera operator the advantages of not having to hold the camera and operate the controls 21, 22, 23 shown in FIG. 8 during operation. Not holding the camera lessons the negative effects of camera operator introduced shakiness and vibration. Additionally, the wireless remote control device allows the camera operator to not be in the picture and his or her blocking of the scene because he or she needing to be next to the camera in order to operate and push buttons to control the operation of the camera. In FIG. 17 an audio-visual signal 116 is transmitted via conventional wireless transceiver means from the camera 1 with adapter 100 to a handheld wireless control device 109. The device 109 may be a wireless handheld control device like that currently sold with the Canon HV10 Camcorder. But additionally, as shown in FIG. 17 it is disclosed in this invention that preferably the wireless control device not only includes control buttons 111 for controlling the camera, but also includes communication means for receiving an audio-visual or video signal from the camera. Besides a handheld wireless controller device 109 it is anticipated and those skilled in the art will realize that the wireless control device can be integrated into a cell phone, PDA, or wireless head mounted display 109a or wrist mounted wireless camcorder remote control device 109b like that illustrated in FIG. 20.

Wireless communications devices, techniques, and standards such as Bluetooth, WIFI, IEEE 802.11b wireless video transmission standards, and others used in transmitting and receiving data between mobile and non-mobile electronic devices are widely know in the industry and are incorporated into the present invention as described in this paragraph. Examples of wireless communications technologies that are incorporated by reference that may be integrated into the present invention includes the Video Cell Phone Model SCH-V300 with 2.4 Megabit/second transfer rate capable of two-way video phone calls; and other wireless satellite and wireless cellular phones using the H.324 and other related standards that allow the transfer of video information between wireless terminals such as the camera 1 with panoramic adapter 100 and wireless control device 109. These systems include MPEG3/MPEG4, H.263 video capabilities, call management features, messaging features, data features including Bluetooth™ wireless technology/CE Bus (USB/Serial) that allows them to be integrated into the camera that works with the panoramic camera system 1 terminals/units. Cellular video phones with a camera 1 integrated with an adapter 100 of a type that can be integrated into the current invention include U.S. Patent Application Publication 2003/0224832 A1 to King et al, U.S. Pat. App. Pub. 2002/0016191 A1 to Ijas et al; and U.S. Pat. App. Pub. 2002/0063855 A1 to Williams et al, all of which the entirety is hereby incorporated by reference. Wireless connectivity can be realized in the camera 1, adapter 100, and remote control device 109 by the use of conventional radio frequency and infrared transceivers. Correspondingly, recent hardware and software/firmware such as Intel™ Centrino™ mobile technology, Bluetooth technology, and Intel's™ Bulverde™ chip processor allows easy and cost-effective incorporation of video camera, controllers, wireless laptops, PDA's, smart cellular phones, HMD's, and so forth that enable wireless devices to conduct panoramic video-conferencing and camera with adapter control according to the present invention. These technologies are part of the components and systems incorporated into the present invention. For example, these wireless technologies are enabling and incorporated into the present invention in order to realize the wireless panoramic camera control unit 109, or the wrist mounted 109b or HMD 109a embodiments used to control the camera 1 with adapter 100. Of course it is anticipated by the present inventor that the camera with panoramic adapter may be mounted on the wrist mounted or HMD for various applications. Computer chips and circuitry which include transceivers allow video and data signals 116a and 116b to be transmitted wirelessly between input, processing, and display means units when distributed mounted on the user's or off the user's. Specifically, for example, the Intel Pro/Wireless 2100 LAN MiniPCI Adapters Types 3A and 3B provide IEEE 802.11b standard technology. The 2100 PCB facilitates wireless transmission of up to eleven megabits per second and can be incorporated into the camera 1 or wireless control unit 109 embodiments of the present invention.

Alternatively, a modem with transceiver may transmit video signals from the camcorder 1 with adapter 100 to the wireless control unit. And the same modem can be integrated to transmit control signals back to the camera. A modem and transceiver to accomplish this is presented in U.S. Pat. No. 6,573,938 B1 dated June 2003, by Schulz et al, the entirety of which is hereby incorporated by reference. Similarly, in U.S. Pat. No. 6,307,589 dated B1 dated October 2001 by Maquire and U.S. Pat. Nos. 6,307,526 dated 23 Oct. 2001 and 6,614,408 B1 dated Septembe 2003 by Mann, the entirety of all being hereby incorporated by reference, wireless modems and signal relay systems that are incorporated into the present invention for sending video signals to the panoramic remote control unit and the panoramic camera to remote devices are disclosed. In those systems they are not used with panoramic recording and control systems. The present invention takes advantage of those systems to advance the art of panoramic videography. Still, alternatively, instead of the videotape cassette that fits into the recording deck of the HV10 or HV20 Camcorder a cassette that has RF transmission capabilities can be inserted into the recording deck to transmit the video signal to the wireless control unit. The wireless video transmitter and receiver unit may be like that described in Radio Electronics magazine articles, such as those by William Sheetes and Rufolf F. Graff, entitled “Wireless Video Camera Link”, dated February 1986 and entitled “Amateur TV Transmitter” dated June 1989 in Popular Science Magazine, the entirety of all being herein incorporated by reference. Similarly, U.S. Pat. No. 5,264,935, dated November 1993, by Nakajima, the entirety of which is hereby incorporated by reference, presents a wireless unit that may be incorporated in the present invention to facilitate wireless video transmission from camera 1 with adapter 100 to a wireless panoramic control unit 109. In this arrangement the wireless video transmitter on the camera transmits the radio frequency signal received from the camera 1 to the receiver located on the remote control unit 109.

Furthermore, software or firmware and computer hardware that facilitates image processing and video display of a viewer selectable undistorted portion of the spherical scene is preferably incorporated into the camera 1 with adapter 100 and wireless control device 109a-c. The camera with adapter or wireless remote control device that the hardware, firmware, and software is integrated into is a still, film, or video camera. Software and hardware for spherical panoramic imagery manipulation and processing will be discussed in more detail below in this specification when referring to FIGS. 22 and 23. In FIG. 17 the video and control signal are transmitted between an antenna located on top of the adapter 100 and an antenna located on the top of the wireless control device 109. As shown in FIGS. 17 and 20 the advantage of placing the transmitting means, such as an antenna or transmitter on top of the adapter, is because it is better communicating relationship as the user moves about the camera and uses the wireless remote control device. References in the above paragraphs provide examples of several embodiments of wireless communication means of a type that are incorporated by reference into the present invention such that the camera with adapter and wireless remote control system can communicate with one another.

Novel transmitter antenna placement, microphone placement, flash placement, novel optical placement, spherical camera design dictates that these devices be located in advantageous locations on the camera to facilitate easy operation of the camera and optimization of the recorded spherical panoramic FOV audio-visual signal. It is claimed by the present invention because of the special design requirements imposed in spherical panoramic photography and videography. And claiming of the design of the novel layout of camera control buttons, viewfinders, sensors, input/output jacks be located on the side or top of camera used for spherical FOV panoramic recording in order to facilitate easy of use by the operator and maximizing the quality of the panoramic signatures recorded by the camera. For instance, in FIGS. 17 and 20 a special spherical camera support stand 113 is disclosed to assist in holding a camera used with the adapter for recording spherical field of view images. The camera mount 118 screws into the stand 113 in the same manner that a conventional tripod screws into conventional cameras, only such that the camera 1 with spherical adapter 100 is oriented with its objective lens facing upward. The present invention anticipates that the stand is made in such a manner that it may attached as shown in FIG. 17 or fastened to tripods and other platforms by straps, screws, or other convention fasteners. While this stand is meant to support existing conventional cameras adapted for taking spherical video images using the adapter, it should be noted that the inventor anticipates the stand being integrated (not shown) into conventional cameras in order to provide buyers the capability to use their cameras to take panoramic imagery according to the present invention. In such an instance, the stand would fold or slide out from the camera (not shown) to support it such that the adapter is positioned in an optimal orientation to record spherical panoramic imagery about the camera like shown in FIGS. 17 and 20.

FIGS. 17-22 also illustrate embodiments of the present invention that incorporate mechanical and/or electro-optical shuttering systems. The purpose of the shutter arrangements are to increase the image resolution and responsiveness of the image selected when using the adapter 100. Beamsplitters, prisms, mirrors, and standard optical components of a type that are integrated into the present invention are sold by Edmund Optics, Inc. of Barrington, N.J.

Prior art mechanical shutters (not shown) of a type that can be incorporated in the present invention include those described in U.S. Pat. No. 6,259,865 to Burke et al and U.S. Pat. No. 6,084,654 to Toporkiewicz. The mechanical shutter is used in the prior art to record sterographic images of a limited field-of-view. For immersive applications it is advantageous to record a panoramic scene of substantially spherical FOV coverage. The above and other prior art which incorporates a plurality of alternating shutters teaches that alternating or selected images in the present invention may be recorded on the single image plane of the camera 1. Specifically '654 involves taking alternating left and right images, and modification would involve an alternating optical paths as taught herein to record images 10a-10b, or 10a-10d, coming from objective lens 7a-7b, or 7a-7d, respectively and depending on the adapter 100 embodiment.

Additionally and more typically, various electro-optical shuttering systems are incorporated into the present invention. The advantage of incorporating shutter systems within the present invention allows the level of light to be controlled that enters the adapter 100 and associated camera 1. As such a shutter system may be incorporated into a conventional HD camera 1 like that shown in FIG. 8. There are many electro-optical arrangements in prior art that use a plurality of shutters to control light coming to a single areas from a plurality of optical paths that may be integrated into the present adapter 100. For instance, in U.S. Pat. No. 5,028,994, by Miyakama et al. a stereographic camcorder with a stereographic taking lens is mounted on a camera body. Such a camera lens was sold by Canon Corporation as the “3D Zoom Lens for the XL1 DV Camcorder” starting in October 2001 and then recalled a few years later. In the present example the adapter 100 and camera 1 cooperate to record alternating images from lens 7a and 7b as opposed to left and right eye images as disclosed in the '994 patent. Specifically, the optical shutters are useful in the present invention are liquid crystal shutters which are capable of transmitting and obstructing light by controlling the voltage, which respond sufficiently fast and with respect to the field scanning frequency of the camcorder 1. Contacts 155 located were the lens mount is located or a cable 110 with the proper connector functions to transmit shutter control signals 123 over associated circuitry and wiring from the shutter control unit 124 to the adapter 100. It will be obvious to those skilled in the art that the control unit may be placed in the camera or adapter. The optical shutters using liquid crystals 121a and 121b may be of approximately the same construction as those previously described in the '994 patent. Since they operate in the same principal, their construction and operation are only briefly described herein. Each of the liquid crystal shutters 121a and 121b comprise deflector plates, the liquid crystal, and the transparent electrodes whereby the liquid crystal shutters are controlled by the driving pulses supplied from the liquid shutter driving circuit/control unit. The liquid crystal shutters become light permeable while the field pulse supplied to the AND circuits that form part of the liquid crystal shutter driving circuit is at a low level. It is also supposed that the field pulse is at a high level for the first field and at a low level for the second field. Therefore, the liquid crystal shutter 121a transmits light in the first field, while the liquid crystal shutter 121b transmits light in the second field. This means that in the first field the light signals of the object image 10a introduced through the first optical path are projected onto the imaging device, while in the second field the light signals of the object image 10b introduced through the second optical path are projected onto the imaging device. The control unit/driving circuitry 125 may be programmed to address the shutters 121a or 121b in an alternating or selective manner. Additionally, any stereographic electro-optical and electro-optical and optical system that uses polarizers my be used like those described in U.S. Pat. No. 5,003,385, dated 1991, by Sudo; U.S. Pat. No. 5,007,715 by Verhulst, dated April 1991, the entirety of all being hereby incorporated by reference my be incorporated into the present invention. Still additionally, manufacturers of LCD shutters of a type that may be incorporated into the present invention are the Hex 63 or Hex 127 Liquid Crystal Cell Spatial Light Modulator (SLM) from Meadowlark Optics Inc, of Boulder, Colo. Meadowlark also sales a SLM Controller in a board configuration that may be incorporated into camera 1 and adapter 100. The units can handle multiple SLM, facilitate selectively and dynamically addressing up to 256 pixels, and can be controlled by computer integrated architecture control. Other manufacturers of SLM's that can be incorporated as the shutter system on the present adapter 100 and camera 1 include Collimated Holes Inc. of Boulder, Colo. SLM products; the Integrated Circuit SLMs-FLC, with 256×256 pixel shutter with computer controller manufactured by Displaytech Inc. of Boulder Nonlinear Systems; and the LCS2-G liquid crystal shutter manufactured by CRL OPTO, GB.

Referring now to FIG. 18 in example, in operation the camera 1 is controlled by a camera operator 126 using camera control means such as buttons 21, 22, 23 on the before mentioned camera or wireless control device 109. Typical control commands include Play, Record, and Stop. Control signals from the camera control 1′ and processing unit are transmitted to the shutter control unit 124. The shutter control unit transmits control signals 123 thru the wiring or circuitry of the adapter to the appropriate shutter 121a or 121b in the adapter 100 to affect the transmission of the transmitted image 10a or 10b. In operation for example control signals 123a sent to a first shutter 121a allows the image 10a from objective lens 7a to be transmitted along the optical path to the image sensor 14 of the camera 1. While at the same time control signal 123b is sent to a second shutter 121b to block the transmitted image 10b coming from objective lens 7b. As demonstrated by the Patents referenced above, the shutters are operated in an alternating manner to achieve successive alternating image frame multiplexing (i.e. a first image from objective lens 7a & video frame #1, then a second image from objective lens 7b & video frame #2, then a third image from objective lens 7a & video frame #3, then a forth image from objective lens 7b & video frame #4, etc.); or operated in a dynamic manner to choose successive image frames in any appropriate manner (i.e. a first image from objective lens 7a & video frame #1, a second image from objective lens 7a & video frame #2, a third image from objective lens 7a & video frame #3, then a forth image from objective lens 7b & video frame #4, etc.). To record the entire spherical panoramic scene continuously the operator will typically specify the adapter to record images transmitted from objective lenses 7a and 7b operate in an alternating manner. Using this recording technique allows the user of the adapter 100 to go back and look at any portion of the spherical FOV scene recorded over a short time interval. Alternatively, an operator may specify that only one shutter 121a or 121b be opened in order to repeatedly record a subject that is only being imaged by one of the objective lenses 7a or 7b respectively. Using a dynamic recording technique in which images are only recorded from a single selected objective lens, say just 7a, allows images from one objective lens to be recorded in closer time intervals, but eliminates the ability to go back and look at a complete spherical FOV scene because images from one of the objective lenses, here 7b, were not selected over that given time interval. Both recording techniques have advantages in given situations. In either case, recorded images are transmitted from the sensor 14 over circuitry and wiring 125 within the camcorder 1. The images 10a and 10b are processed within the camera 1 and transmitted for display. Display may be on the viewfinders of the camera, an attached display such as a television or computer monitor, or on any of the afore mentioned wireless control device's displays.

Still referring to FIG. 18, also in operation when shutter 121a or 121b is open a hemispherical image 10a or 10b respectively of greater than 180 degrees is transmitted thru objective fisheye lens 7a or 7b respectively which has a greater than 180 degrees hemispherical FOV coverage. The image transmitted through the objective lens 7a is refracted and reflected at a 45 degree optical axis by the mirrored surface within the beam splitter 122. A relay lens, magnifier, or reducing lens 103 may be incorporated if needed to enlarge or reduce the transmitted image 10a. The integral fixed objective and relay lens 4 of the camera 1 are operated to focus the image displayed at the camera side of the image plane of the beam splitter 122 onto the image sensor 14 of the camera 1. Likewise, in operation when shutter 121b is open a hemispherical image of greater than 180 degrees is transmitted thru objective fisheye lens 7b which has a greater than 180 degrees hemispherical FOV coverage. The image transmitted through the objective lens 7b is transmitted directly along the optical axis where it is reflected between mirrors 11a-c oriented at 45 degrees to the beam splitter 122. The image 10b reflected between the mirrors 11a-c is transmitted thru the beam splitter 122, through camera optics 4, and then to the camera sensor 14. A relay lens, magnifier, or reducing lens 103 may be incorporated if needed to changed the size of the transmitted image 10b. Changing the size of the transmitted image may be necessary to compensate for the size of the image as it moves through the optical path in order to achieve the desired image size when it reaches the sensor. Normally the goal will be to fill the frame 16, 17 to the maximum amount possible in order achieve higher resolution of the captured subject image 10a or 10b. The camcorder's integral fixed objective and relay lens 4 are operated to focus the image displayed at the image focal plane of the beam splitter onto the cameras image sensor. The objective fisheye lenses 7a and 7b are situated in a back-to-back manner such that they have overlapping adjacent hemispherical FOV coverage such that a spherical FOV is achieved.

As illustrated in FIGS. 4 and 5, images 10a and 10b from the adapter are imaged on the camera or camcorders sensor 14. Typically the entire frame is read out from the camera 1. One frame 16 or 17 may include image segments representing the entire surrounding panoramic scene. Alternatively a sequence of frames 16 or 17 may be read out that have segments which when put together comprises an entire surrounding panoramic scene. The images are then processed by a computer 143 separate from the camera or camcorder in preparation for panoramic viewing. The image is then read out from the camera or camcorder in near real-time/live or may be read out the playback mode.

Alternatively, panoramic image processing and display can be accomplished on board a camera or camcorder 1 with images recorded from any of the camera embodiments described in the present invention. The adapter may be of a passive design as described in FIGS. 8 thru 16, or be comprised of an active design as shown in FIGS. 17 thru 22, where alternating or dynamically selected images are read out by the camera 1. Panoramic image processing in the present invention includes and comprises such functions of balancing chrominance and luminance and contrast between subset images and image segments, read out of images, stitching images, determining area the area of display, and panning and zooming around panoramic images for display. With either the passive or active design embodiments presented in the present invention firmware is integrated/embedded into the camera processing means 1′ and wireless remote control means 109 to facilitate this functionality. Obviously, those skilled in the art will also realize a micro-processing chip to accomplish the functions mentioned in this paragraph can also be embedded into the adapter 100.

Similarly, Region-of-Interest (ROI) firmware is embedded into the camera 100 to cause the processing means (firmware and hardware) 1′ within the camera to selectively or dynamically readout only portions of the image or images displayed on a frame. The region of interest firmware may be embedded into the imaging chip 14 (also called the image sensor) of the camera 1. The frame may be a still frame image or from consecutive video image frames. A limited example of this functionality exists within the Canon HV10 and HV20 camcorder and is referred to as “Magnifying the Playback Image”. It is well known to those in the art that that for ROI image processing the solution may be software, firmware, and/or on sensor hardware solution. An example of an ROI image processing sensor and sensor arrangements of a type that may be integrated into the camera 1 with adapter 100 of the present invention are described in U.S. patent application Ser. No. 11/432,568 entitled “Volumetric Panoramic Sensor Systems” filed May 11, 2006; U.S. Patent Application Serial No. 20070182812 filed Aug. 9, 2007 entitled “Improved Panoramic Image-Based Virtual Reality/Telepresence Audio-Visual System and Method”; and U.S. Patent Application 20070002131 filed Jan. 4, 2007 entitled “Dynamic interactive region-of-interest panoramic/three dimensional immersive communication system and method” submitted by the present inventor and currently being reviewed by the U.S. PTO. Control signals from within the camera, a remote wireless camera control device, or a connected computer can be used to communicate to the camera means which portion or portions of the composite spherical FOV images are readout.

Specifically, a CMOS sensor 14 with ROI capabilities of a type suitable for use in the present invention is the Dalsa 2 m30-SA, manufactured by Dalsa, Inc., Waterlloo, Ontario, Canada, has a 2048×2048 pixel resolution with a color capability and incorporates ROI processing on the image sensing chip. In the present invention this allows users to read out the image area of interest the user is looking at instead of the entire 2K×2K picture. Another example of a sensor 14 of a type with ROI capabilities that may be used in camera 1 is the Quad HDTV High Resolution Color/Monochrome Video Sensor by Silicon Video Inc. and 3840K×2160K sensor sold by VPS, Inc. whose capabilities are described in U.S. Pat. No. 6,084,229. Multiple ROI can be read out selectively and dynamically in any sequence that is programmed into the computer processing capability that controls the sensor. The ROI sensor is dynamically and selectively addressed depending on the view selected by the user 126, 126′ or 126″ of the interactive control device 144. The CMOS sensor on camera 1 with adapter 100 is addressable using software or firmware integrated located on the computer with ROI software or firmware. That computer may be located on the wireless interactive control device 144 associated with processing and display device 109, 109′, 109″, PC 147, HMD 145, display room 146, or similar type devices.

For instance, in FIGS. 6 and 7 illustrates the selection of a region-of-interest (ROI) area subset within an image frame 17 captured by a camera 1 with an adapter 100. Areas 10a and 10b represent two regions comprising hemispherical images recorded by the camera with two objective lenses 10a and 10b like that shown in FIG. 8. In this system only one view of every portion of the scene is recorded in the composite image 10a and 10b spherical field-of-view. As such, only a monoscopic or binocular panoramic view can be is sampled out for viewing. The inset rectangle represents the left “L” eye and right “R” eye monoscopic field-of-view, with the overlapping eye FOV being hatched in the center of the rectangle. In FIG. 6 the entire ROI is subset in image 10a. In contrast, in FIG. 7 the ROI is divided between image 10a and image 10b. FIG. 17 graphically illustrates an instance where the image of a person is captured in a small portion of the image 10a shown in the viewfinder 16 of the camera 1, like in FIG. 6. And then the image 10a is ROI processed such that it is enlarged for viewing on the display 16 of the wireless camera control device 109. In this example the image processing to achieve this effect is either operated upon either on the camera 1 or in the wireless control device 109. If done in the camera the image processing can be done on a special image sensor 14′ with ROI capability in the camera. Those skilled in the art will understand that the present invention may be designed so that this image processing also takes place in an image processor built into the adapter 100 without departing from the spirit of the present invention. In operation circuitry and wiring 123, 124, 125, 1′ of camera 1 is connected through cables 110, connectors or contacts 155 to the adapter 100 in order to provide electrical power, input and output and control of components “119 all” such as microphones, wireless transceivers, flashes, light meter sensors, timers and other indicators, adapter processing, and so on and so forth located in the adapter 100.

Components 119 all of a type that are integrated into embodiments of the adapter in the present invention are found on the Canon HV10, HV20, and other standard camcorders. More specifically, a modular panoramic microphone array of a type that may be incorporated into the present invention is described in U.S. Pat. App. Pub. 2003/0209383 A1; U.S. Pat. No. 6,654,019 hardware and software by Gilbert et al; and by the present inventor in U.S. Pat. Nos. 5,130,794 and 5,495,576, the entirety of all which are incorporated herein by reference.

FIG. 18 is a diagramatic cutaway perspective of the electro-optical system of the adapter 100 with spherical field-of-view coverage in which the optical system that incorporates a cube beamsplitter 122 and mechanical or electro-optical shutter system 121a, 121b, 122, 123, and 124 that facilitates selected monoscopic or binocular frame images to be recorded by an associated camera control 1′ with electro-optical control and processing capabilities. Control signals from the shutter control unit 124 transmit signals over circuitry or wiring 123 to effect the amount of light and if the image transmission thru shutter 121a and 121b to the image sensor 14 of the camera 1.

FIG. 19 is a diagramatic cutaway perspective of the adapter lens optical system with spherical field-of-view coverage in which the optical system which incorporates a lateral displacement beamsplitter 122 and mechanical or electro-optical shutter system 121a, 121b, 122, 123, and 124 that facilitates selected monoscopic or binocular dynamically sampled or frame multiplexed images to be recorded by an associated camera control 1′ with electro-optical control and processing capabilities.

Yet alternatively FIG. 20 shows an exterior perspective of another embodiment of an adapter lens system for recording stereoscopic spherical field-of-view images. Specifically, special electro-optical processing systems integrated into camera 1 and adapter 100 allow any four of the optical paths to be dynamically addressed.

FIG. 20 also illustrates two other alternatives for wirelessly interacting with a camera 1 with adapter 100 where the camera operator 126 either wears a head mounted wireless camera control and display system 109a or wrist mounted wireless camera control and display system 109b. Electronics and communications in FIG. 20-22 are similar to that described as previously discussed in this specification under FIG. 17-20, however additional components have been added to capture and process stereoscopic imagery.

In FIG. 20-22 a spherical FOV panoramic adapter 100 is provided that facilitates camera 1 recording panoramic images 10a, 10b, 10c, and 10d. In these stereoscopic embodiments of the present invention at least two objective lenses 7a, 7b, 7c, and 7d have overlapping coverage at any one time such that at least two views of the surrounding subject/scene are recorded in an aggregate 360 degree FOV manner. Here each lens has a 185 degree FOV. Preferably very high resolution image sensors or film are used to record stereoscopic imagery in order to maintain good image resolution when a portion of the final image is presented to the viewer. High Definition Cameras or Camcorders of the type previously discussed in this specification are preferably incorporated, but those skilled in the art will realize that various cameras and camcorders may be used without departing from the spirit of the invention. In such an instance the adapter 100 is typically mounted in onto the filter mount of the camcorder 1. Lens 4 of camcorder 1 is adjusted to focus in on the images 10a, 10b, 10c, and 10d as they are presented in focus in the adapter 100.

FIG. 21 is a diagrammatic cutaway perspective of the adapter 100 optical system with spherical field-of-view coverage for recording stereoscopic spherical field-of-view panoramic images in which the optical system incorporates cube beam splitters 122a, 122b, and 122c. For example, in operation objective lens 7a transmits a 185 degree image. The image is transmitted to mirrors oriented at 45 degree angles. The three mirrors 11a 1-3 reflect the image to the entrance end of the beam splitters. The image is transmitted through three beam splitters. The image 10a is transmitted because the camera operator 126 has put a command into the camera via the camera control processing system 1′ which electronically commands the shutter control unit 124 to send electronic signals through wiring or circuitry 123a-d to the camera shutters 121a-d respectively. Camera shutter 121a is commanded to open and let image 10a be transmitted through the optical path to the image sensor of the camera. Camera shutters 121b, 121c, and 121d are commended electronically to be closed and block images 10b, 10c, and 10d from being transmitted to the image sensor of the camera. Similarly, the camera 1′ is operated by the camera operator 126 to open and close other shutters in the camera in a manner that determines which image is transmitted to the camera for display and processing. It is known the art that pezo-electric, LCD, SLM, LED, and mechanical shutters types and configurations can be incorporated into the adapter 100 without departing from the spirit of the present invention. One image 10a, 10b, 10c, or 10d is captured by the camera 1′ at a given time in the adapter embodiment shown in FIG. 21.

Alternatively it is understood that it is possible to design a camera to adapter configuration were one part of the shutter may be closed and another portion open to begin the scan of a different image. But preferably one complete image is captured at a time in a progressively scanned manner. Relay and magnifying optic 103a-c, for example, are incorporated to ensure the image is transmitted to the exit end of the last beam splitter in a uniform size for the camera to focus upon. The focusing lenses 4 are controlled by the camera control 1′ unit in camera 1. Control unit 1′ also transmits control, power, and read out signals 125 to and from the image sensor 14 such that the sensor stays in synchronization with the shutters controlled by shutter control unit 124. And finally the central processing control unit of the camera also controls the synchronization and operation of any other electronic and electro-optical functions designed into adapter 100 such as transceivers, flashes, microphones, light sensors, indicator lights, and so on and so forth.

FIG. 22 is a diagrammatic cutaway perspective of the adapter 100 optical system with spherical field-of-view coverage for recording stereoscopic spherical field-of-view panoramic images in which the optical system incorporates bream splitters. In contrast to FIG. 21 in which one image from any one of the four fisheye lenses may be selected for recording, in FIG. 22 two back-to-back images from back-to-back to back fisheyes are recorded in each frame interval. For example, in operation hemispherical images 10b and 10d from respective fisheye lenses 7b and 7d to mirrors 11b 1-2 and 11d 1-2 oriented at 45 degree angles along the optical path b and d. From the mirrors the images are reflected into the beam splitters. The image 10b from objective 7b are reflected into the top of the beam splitter 122a and the image 10d from objective 7d is reflected into the top of the beam splitter 122b. The images are presented in focus on the surface of the two beam splitters 122a and 122b on the camera side of the beam splitters. And the objective lens 4 of the camera is focused onto the images 10b and 10d presented by the beam splitters. Meanwhile the shutters 121a and 121c remain closed so that respective images 10a and 10b are not transmitted thru the optical system at the same time shutters 121b and 121d are open and transmitting images 10a and 10c. In contrast, in a different instance when shutter 121a and 121c are open hemispherical images 10a and 10c from respective fisheye lenses 7a and 7c are transmitted to mirrors 11a 1-2 and 11c 1-2 oriented at 45 degree angles along the optical path a and c. The mirrors 11a and 11c respectively reflect their images into the sides of beam splitters 122a and 122c respectively. The mirror in the beam splitter reflects the images 10a and 10c at a 45 degree angle to the surface of each of the respective cube beam splitters. Meanwhile the shutters 121b and 121d remain closed so that respective images 10b and 10d are not transmitted thru the optical system at the same time shutters 121a and 121c are open and transmitting images 10a and 10c. In operation preferably one set of images 10a and 10c are recorded on one frame at one time, or images 10b and 10d are recorded on one frame. Frames may be recorded dynamically or in a set alternating frame multiplexed manner well know in the video industry.

Still referring to FIG. 22, in operation the camera operator operates the camera to control the camera control 1′ processing. Camera control processing 1′ firmware and hardware is integrated with the shutter control unit 124 and sensor 14 firmware and electronic hardware, such as circuitry and wiring, that controls shutter opening and closing, image sensor operation, and other electronic and electro-optical functions 119 et al designed into adapter 100 such as transceivers, flashes, microphones, light sensors, indicator lights, and so on and so forth similar to that already described in FIG. 21. It will be understood by those skilled in the art that various types of shutters and various types of beam splitters can be used in the present invention without departing from the spirit of the present invention.

FIG. 23 shows a process and method 129 for manipulating video images recorded by the adapter lens 100 according to the present invention. Individual processing operations are described in steps 129a-138. Arrows indicate the normal order in which the processes are operated upon. Instance 1 127 represents operations that must be accomplished initially to establish a baseline registration, but that can be skipped subsequently unless the establish baseline changes. Instance 2 128 represents operations that must be accomplished repeatedly even after the baseline registration is established. Typically, the present invention the process is implemented into the software or firmware resident in the camera 1 and/or wireless remote control device 109, 109a, or 109b. Alternatively, memory and processing chip(s) and associated electronics are embedded into the adapter to also perform processes for manipulating the recorded panoramic image. Individually the computer operations described in process 129 are not novel, and are well known in the art, however combining the operations into the present invention in the manner disclosed is novel. While each step can be performed separately, the entire process can be automated. And while one operation is being performed another process can be performed on subsequent images in memory such that viewing takes place in near-real-time from the viewer standpoint. Image process 129, parameters (i.e. such as the FOV the viewer will observe) are pre-defined by an operator or viewer during camera, adapter, wireless control device, or host computer setup so that image viewing is accomplished in near real time in an automated fashion when imagery from camera 1 using adapter 100 is read into these devices. The process may be implemented on live or pre-recorded imagery. The operator/viewer typically uses buttons and mini-joysticks 111, and a menu displayed on the camera, wireless control device, or a host computer to accomplish the set-up.

Still referring to FIG. 23, in operation the camera 1 with adapter 100 records panoramic digital video images according to the present invention. The panoramic images, say 10a and 10b for example, are recorded into the memory of the camera according to step 129a. After reading the panoramic image into memory the image processing means performs processing operations 130 to locate the position of the images within the frame and relationship spatially to one another. Images 10a and 10b must be registered in the xy area of the planar frame format so that the correct ROI can be sampled for subsequent image processing operations. Additionally, the two-dimensional subset images 10a and 10b must be registered to the three dimensional world coordinate system from which the imagery is taken. The imagery data is translated into lookup tables or algorithms relating 2D to 3D points and areas of the recorded imagery. This is done so that ROI's in imagery 10a and 10b can be sampled out for viewing using the look-up tables or algorithms. The operation of registering the initial images 10a and 10b must be done whenever image lay-down location is registered for the first time or whenever the lay-down of the image on the frame changes according to Instance 1. The xy registration of the images are translated into a lookup tables in which the two-dimensional xy coordinates on the planar images 10a and 10b correlate to three-dimensional xyz coordinates corresponding to the real world spherical panoramic scene recorded into imagery by the camera 1 using the panoramic adapter 100. The reason registration is typically performed when a new series of images are presented for processing is because image lay-down is likely to change when a different adapter is used because the exact location of where the images are likely to reflected and refracted into the camera 1 from the adapter 100 is likely to change in different recording instances. Additionally adapter embodiments may be different causing the lay-down of the location and number of images subset on the frame to be different. For instance one, two, or four images may be recorded in a single frame, depending on the camera used to record the imagery. In viewing prerecorded images whether or not registration of the panoramic images is a concern depends on the degree to which post processing has occurred and the degree to which the same image registration from recording to recording is maintained. If the panoramic video clips have not been registered then it is likely that registration will be required. But as defined by Instance 2, if the panoramic clips have been registered to one another to be consistent from frame to frame then no registration may be required.

As described in FIG. 23 and FIG. 24, once the subset imagery has been registered imagery is sampled out for viewing based on the operator/viewers 0′, 126′, 126″, 148 interactive inputs 137, 144. The (′ and ″) symbols indicate the operators and users may be the same person or a different person in this instance. In other words, the camera operator can also be the operator 126, 126′ of the client computer and user 126″of the HMD with 3D tracking. Conventional two and three dimensional interactive input devices and means such as a mouse, keyboard, joysticks, or three-dimensional position sensing system may be incorporated. These devices are used with or as part of the present invention to designate which portions of the recorded panoramic scene the viewer wants to observe. The interactive input devices are connected to a conventional computer. The conventional computer processing means is incorporated within the present invention or used with the present invention to process imagery recorded by the camera with adapter 100. The conventional computer processing means my be integrated into camera 1, the adapter 100, wireless remote control device 109, 109a, 109b, a cell phone, laptop computer, personal computer, personal digital assistant (PDA), or other device well know in the industry that can typically include memory, processing circuitry, wiring, input means, electrical power means, processing means, and display means typical to any conventional computer processing system or modern electronic device.

Referring once again to FIG. 23, once the viewer has designated the ROI to be sampled out in step 137 of the process then steps 131-136 are typically performed to prepare the image for viewing. Steps 131-136 include matching image edges of image segments 132, translating image segments 132, reversing and inverting image segments 133, stitching image segments 134, saving into memory the final image for display 135, and finally reading out the resultant image and audio signal for presentation to the viewer based on his or her input 136. Simultaneously while imagery for viewing is being processed and displayed based on subsequent user input, the firmware or software is being operated upon in step 137 by the hardware to determine the next ROI to display in step 138 such that a continuous panoramic scene is available to the viewer.

Again, this can be implemented in the form of a look-up table or algorithm. For example, once image 10a and 10b are found to be in a certain location within a frame as described in step 130, then it can also be determined that certain locations along the hemispherical images 10a and 10b match-up according to step 131. Unless the hemispherical orientation changes the same coordinates referenced will be constant from frame to frame.

The spherical panoramic image processing operations 129 laid out in FIG. 23 for manipulating wide angle hemispherical images, such as images 10a and 10b, according to the present invention are known in the industry and may be accomplished using the below mentioned software. However the use of the below software with a panoramic adapter 100 like that described in the present invention has hereto not been realized in prior art. As previously mentioned the panoramic software is installed as firmware onboard the camera 1, adapter 100, or remote control 109 system of the present invention. Installing software as embedded firmware is well known by those skilled in the art. Specific software of a type that is embedded into the instruction set of a camera or wireless control devices computer processing system, PDA, cellular phone, or on an adjacent computer is manufactured by Spherical Panorama, Inc., of Ukraine. Specific products for stitching and viewing imagery recorded by cameras using the present panoramic spherical adapter lens include: SP_VTB; SP_SC; SP_VIDEO; SP_MT; SP_{—}3DC; SP_VST; SP_RE; SP_CVST; SP_JAVA; SP_ST; SP_DLL; SP_SPF; and SP_JPEG.

Specifically, as incorporated into the present invention SP_VIDEO software allows a user to process and view 360-degree x,y,z spherical video. Applications include video-business, real estate business, tourist services, private viewing, or live webcam. The SP_VIDEO software has a viewer of minimal size which gives additional convenience of use in integrated camera and wireless panoramic video control applications such as that described in the present invention. To date the application software is being used in laptops, PDA's, cellular phones, webcams, and other portable and broadcast applications. Also, to date the software is being used for video-presentations, and professional panoramic movies on CD-R, CD-RW, DVD+R, DVD-RW in conventional applications. The viewer consists of a small module which makes it attractive for portable devices such as the present invention.

The SP software contains the following solutions, some necessary for playback on within the present invention, and some for use in viewing live spherical video in near real time when using the camcorder 1 with adapter 100:

Processing of spherical two fisheye imagery for display for viewing

Viewing of spherical panoramic video

Customize viewer graphic skin and scene visually

Special video effects

“loop” mode

“Remote control” mode for extended type of the viewer such as webcams

Using any codec (video/audio)

A set-up menu guides the user through the process of capture, processing and displaying imagery in a step by step manner. An SP auto-parser is used to grab the hemispherical images 10a and 10b recorded by the present lens adapter and process (translate, rotate, reverse, and stitch the two hemispherical images frame after frame) the specific portion of the image designated by the operator/viewer of the scene is integrated into the software. The software is typically run on a client computer 143. The software may be implemented in the form of firmware in the present invention where a programmable microchip is preferably incorporated into the camera 1 or wireless remote control devices 104 or 109.

Still referring to FIG. 23, additional panoramic image manipulation software and firmware of a type that may be integrated into the image processing means of the present invention is illustrated. Spherical panoramic image processing operations 129 in the form of computer programs in a compatible language to a given computer system to manipulate image 10a, 10b, 10c, or 10d or portions of those images includes: Internet Pictures Corporation's Interactive Studio and Immersive 360 Movie Production Software; Ford Oxaal of MindsEye Inc. using PictoSphere software in U.S. Pat. No. 5,684,937, 2004/0004621 A1, U.S. Pat. No. 6,271,853 B1, 6,252,603 B1, 6,243,099 B1, 6,157,385, 5,936,630, 5,903,782, and 5,684,937); those from iMove Incorporated in U.S. Pats. 2002/0089587 A1, U.S. Pat. No. 6,323,858, 2002/0196330, U.S. Pat. Nos. 6,337,683 B1, and 5,654,019 B2; that in U.S. Pat. No. 6,018,349 by Microsoft; those in U.S. Pat. No. 5,694,531 by Golin et al; U.S. Pat. No. 6,323,858 B1; a freeware product called Panoramic Tools and PT Viewer by Helmet Dersch of Germany; US. Pat 2002/0063802 A1 by Gullichsen et al; Panoview Inc's Panoweaver software of Hong Kong, CH; software and firmware algorithms for authoring and viewing high resolution immersive videos sited in a paper titled “High Resolution Full Spherical Videos” by Frank Nielsen of Sony Computer Science Laboratories Inc., Tokyo, JP; and software and firmware referenced in the present inventors previously issued, provisional, and pending U.S. Patent Applications cited elsewhere in the present invention are included here as enabling technologies to the present invention in their entirety.

FIG. 24 illustrates a network architecture 125a that facilitates the recording, processing, and displaying of the panoramic scene recorded by camera 1 and adapter 100. The systems in the network are comprised of conventional camera 1, computers 139 and 143, and communication devices which make up the local area network (LAN), campus area network (CAN), or Wide Area Network (WAN) 141 typical in today's telecommunications world which are linked together by conventional landline and over-the-air materials and devices. Arrows indicate the communication and transmission links between the devices in the architecture 125a. While the operation and interaction of these devices in their traditional sense is well know in the art, the combination and use of these systems with the panoramic adapter 100 and other related disclosed components and software/firmware that comprise the present invention is novel. In fact, that is one of the benefits of the adapter. That is the panoramic adapter is able to be integrated with existing camera, processing, telecommunication, and display systems. For instance, the interface and interaction of the camcorder 1 with panoramic adapter 100 with such external devices is described in the Canon HV10 and HV20 HDV Camcorder Instruction Manual; Pub. DIM-767, by Canon Inc. 2006; and the Canon Digital Video Software Instruction Manual, Ver. 23, DIE-267W, by Canon Inc. 2006, and compatible HDV Video post production, live broadcast, and production software. The interaction of the adapter and camera has already been described in great detail so only be discussed as it applies to the network 125a in the following paragraphs.

Still referring to FIG. 24, the digital video signal received from the camera 1, 109, with adapter 100 is received by a host server 139 in an alternative embodiment 142 of the network 125a in which a telecommunications system is integrated with the adapter 100. In operation camera 1 transmits an entire frame with, say images 10a and 10b, to the host server 139, or a subset image/ROI sampled out of images 10a and 10b is read out to the host server 139. Host server 139 systems and LAN/WAN 141 systems for processing information for transmission and reception over communication networks and their components and subcomponents of a type compatible with the present invention are well known in the industry and are used in the present invention. The image or series of images are typically transmitted using conventional telecommunication devices over a Local Area Network or Wide Area Network 141 to a client computer 143. Alternatively, the signal representing the panoramic scene from originating from adapter 100 that is transmitted from server 139 is sent to portable devices, such as cell phones and personal digital assistants, or laptops with a wide-area wireless remote network capability.

Telecommunication networks which the current system can communicate over include that in U.S. Pat. App. Pub. 2002/0093948 A1; U.S. Pat. App. Pub. 2002/0184630 A1 Dertzet al.; U.S. Pat. App. Pub. 2004/0012620 A1, by Buhler et al.; U.S. Pat. App. Pub. 2002/0031086 A1 by Welin; U.S. Pat. No. 5,585,850 by Schwaller; U.S. Pat. No. 6,587,450 by Pasanen; U.S. Pat. No. 5,551,624 by Horstein et al; and U.S. Pat. No. 5,481,546 by Dinkins, all of which the entirety is hereby incorporated by reference. LAN/WAN telecommunications systems compatible with the present invention include landline and over-the-air (i.e. satellite) networks for cable television, internet service, telephone and cellular phone service.

It should be noted that the raw images 10a and 10b may be processed for display at any point along the recoding and transmission path by panoramic signal processing means which includes computer hardware and software or firmware once the image is imaged on the sensor of the camera 1 with the adapter 100. Signal processing means typically includes both image and audio processing capabilities, however it may include just one or the other. The panoramic images may be processed in the associated camera 1, panoramic adapter 100, remote control device 104, 109, host server 139, client computer 143 (which could be a conventional personal computer or a set-top box on a TV), or processing integrated into the display 145, 146, 147 or interactive input device 144. If the processing is done on the camera it may be done at the chip level (i.e. ROI processing) and/or by the camera image processing means of the camera, depending upon the design of the camera system. At the adapter level, impromptu pre-processing is possible by controlling the shutters onboard the adapter so that only selected imagery is allowed to be transmitted to the camera. Alternatively, processing of the panoramic imagery may also be done by software or firmware installed in the interactive input device or display device. Typically and traditionally, however, the signal processing of the panoramic image will be accomplished by panoramic signal processing software that has been installed into a host server or client computer.

While the camera 1 with panoramic adapter 100 may be part of a telecommunications system or LAN/WAN system it should be obvious to those skilled in the art that alternatively the camera with adapter is also able to be connected directly to a client computer 143. In such an instance a host server and LAN/WAN system would not be used. But in any case, once the image reaches the client computer 143 the image is transmitted to a display device 145, 146, 147. At that point typically the operator 126, 126′ 126″ or 148 operates interactive input device 144 to define the portion of the panoramic scene he or she wishes to receive audio-visual presentation. Obviously, the camera control selections the camera operator 0 or 126 chooses and the up-stream processing already accomplished will effect the down-stream processing and display options. Preferably, the downstream operator 0′ or 126′ controls or has say in the original recordings made using camera and processing so that he or she can select which portions of the spherical FOV image he or she wishes to manipulate and view, otherwise his or her options on viewing the spherical scene will be limited by someone else up-stream.

Display devices that are compatible with the camera and adapter systems described herein include head mounted display devices (HMDs) 145, room surround audio-visual presentation systems and large surround theaters 146, and conventional monitor display systems 147. It is widely known within the art how to operate and connect the computers, processing, and audio-visual systems and devices of a type that are integrated into the present invention, so that will not be dwelt on in this specification. Display devices that are compatible with the present invention include conventional HMDs 145. Preferably, the HMD at least has an interactive input device 144 in the form of a position sensing system integrated. Signals on position, orientation, yaw, roll, and heading are read-out from the HMD's interactive input device 144 to the client computer 143, host server 139, camera 1, or panoramic adapter 100 to define the scene that is processed for display to the operator interacting with the presented scene. Likewise, another display device that is compatible with the present invention include VideoRoom™, RealityRoom™, or Computer Automated Virtual Environments (CAVE) Systems. With these room-like systems the entire spherical field of view image that is derived from the camera 1 with adapter 100 records is preferably displayed on wall, ceiling, and floor on which the viewer is standing as a continuous scene. Finally, a conventional display monitor with a conventional keyboard, mouse, or joystick or trackball may also be used to interact with the clients computer. Typically, the client computer 143 will be a standard personal computer (PC) that has the conventional capabilities that enable the operator to hook the camera with adapter to the PC to view live or pre-recorded panoramic video. Typically, and continuing with our current example, the two hemispherical images recorded by the HV10 camera 1 are transmitted over a 1394-IEEE Standard FIREWIRE connection to a host 139 or client 143 computer for image processing and display. Other connections may include a USB or DVMI connections, like that on the Canon HV10 or HV20 Camcorder. HMD's and Panoramic room displays of a type for use in the present invention are described in U.S. Pat. Nos. 5,130,794, 5,495,576, U.S. Patent Application Serial No. 20070182812, and U.S. Patent Application 20070002131 by the present inventor, all of which the entirety is hereby incorporated by reference.

As an alternative 142, the client computer 143 may be connected to the internet. In this instance, the operator 126′ uses his or her client computer 143 to interact with live or pre-recorded panoramic image from camera 1 with the panoramic adapter 100 transmitted from a remote location. In one embodiment a camera 1 with panoramic adapter is controlled by a host computer 139 which functions as the server to send the panoramic imagery over a LAN or WAN to the User(s) 126″ or 148. Similarly, in another embodiment the host computer 139 functions as a server to send pre-recorded information housed in it's memory to a client computer 143. It is anticipated that operators and users located at each end of a telecommunication system will operate the network 125a in one-way, two-way, and multi-person communication environments. And it is anticipated that much of the users will operate their computers and display systems to play pre-recorded panoramic imagery on their PC located on a host server operated by an internet service provider. Images derived from the adapter located in a surrounding subject environment are either transmitted in whole or in sub-segments for presentation. Which up-stream camera 1 and adapter 100 embodiments, set-up, and video signal processing are implemented will define the downstream processing and image and audio signal required.

As final examples, FIGS. 25-28 illustrates several novel embodiments in which the camera 1 with adapter 100 described in the present invention are incorporated.

FIG. 25 illustrates the camera with the panoramic adapter 100 mounted on a helmet 161. The camera is mounted onto the top of the helmet. The helmet is mounted onto the helmet via a metal or plastic bracket 162 that is fastened to the camera and the helmet via in a traditional manner such as nuts and screws. The bracket which is connected to the helmet is also connected to the cameras tripod mount located on the base of the camera 1 via a screw in order to securely hold the camera onto the bracket. Preferably the bracket 162 includes a hinged swivel that allows the bracket holding the camera with adapter 100 to be rotated and locked in place. Such a bracket is frequently incorporated on camera tripod mounts to rotate and hold a camera in place. The advantage of being able to rotate the camera with adapter is that it may be placed in a stowed position for concealment and protection when moving. A further advantage to being able to rotate the camera and adapter is that it allows the adapter to be moved into a position so that the adapter has an advantageous viewing position such as the seeing the face of the person wearing the helmet or raised over the person wearing the helmet so that the scene surrounding the person wearing the helmet can be better observed. It will be apparent to those skilled in the art and is anticipated by the viewer that imagery being recorded by the wearer of the helmet will be broadcast to remote locations using wireless communications devices mounted on the helmet or carried elsewhere by the wearer of the helmet. It is also anticipated that some components other than the optical and sensor components, such as the portable battery, tape recorder, and so forth that make up the camera 1 and adapter 100 may be distributed elsewhere on the helmet, clothing, or uniform for ease of carrying and for concealment purposes. It is also anticipated that various hats, helmets, and headsets may be incorporated. And it is anticipated that the imagery will be displayed to the wearer of the helmet on such devices as a wrist mounted device or helmet mounted device. It is also anticipated that the camera system will be controlled by a wire or wireless remote control device that is operated by the wearer or by another person. And it is anticipated that various image sensors such as passive and active infrared night vision systems and various reconnaissance, intelligence, surveillance, and target acquisition (RISTA) systems may be integrated into the camera without straying from the scope of the present invention.

FIG. 26a-FIG. 26c are prior art photographs of an acoustical system 165 with microphones 20a-nth oriented in various directions outward from a housing 101 on a mast that can be used for determining direction of small-arms weapons fire. The “Boomerang” mobile acoustical shooter detection system, manufactured by BBN, Inc. is mounted on military vehicles that accomplish this task. The system can be integrated with a remotely controlled weapons system 170 like the TRAP T-250 or CROWS remotely controlled weapon system (described below). Additionally the Boomerang weapon system includes a Weapon Watch EO/IR and Enhanced Tactical Automated Secruity System (eTASS) sensor fusion system and C2 System developed by Northrup Grumman. The remotely remotely controlled weapon system and Boomerang User Interface have been integrated as part of a total Fire Control and Target Acquisition Systems (FC/TAS) 172. However, to date the microphone system incorporated in the Boomerang acoustical direction system that detects the relative azimuth, range, and elevation of the incoming small arms fire has not been integrated with a panoramic adapter 100 with camera system like that anticipated and described in the present invention. And the system has not been integrated into a HMD system with position sensing. It is anticipated by the present inventor that the microphones 20a-nth in this acoustical sensor system are integrated into the upper part of the panoramic adapter 100 housing 101 to perform the same function. In operation acoustical data would be sent to the FC&TAS from the microphones in the adapter 100. The data would then be operated on and presented on the HMD or flat panel display to the operator to assist the operator in engaging targets. FIG. 17 and FIG. 20 illustrate microphones 119 et al placed facing outward from the adapter 100. In incorporating the Boomerang microphones 20a-nth into the present invention the microphones are extended outward from the upper portion of the adapter into the dead-spaces where the adjacent field-of-view lens coverage is not overlapping between the objective lenses of the adapter. In this way the microphones 20a-nth do not get into the field-of-view of the panoramic images being recorded by the objective lenses of the adapter. It will be obvious to those skilled in the art that the exact design and placement of the microphones on the top of the adapter can be adjusted without departing from the scope of the present invention.

FIG. 27a-FIG. 27c are prior art photographs of the XM101 Common Remotely Operated Weapon Station (CROWS) 170, manufactured by Recon Optical, Inc. (ROI) based in Barrington, II. The CROWS provides the capability to remotely operate crew served weapons. consists of a Fire Control/Target Acquisition System (FC/TAS) 172 with a forward looking daytime video camera, second-generation FLIR and laser rangefinder and weapon system mounted on a combat vehicle. An operator 175 operates the system to engage targets using a flat panel display 173 and joystick 174 mounted inside the combat vehicle 176. The present CROWS camera, FC/TAS, and display lack the ability to provide a panoramic scene about the vehicle. The present system also lacks a head-mounted display with position sensing to assist in engaging targets in a more accurate and more rapid manner.

FIG. 28a-FIG. 28c are illustrations an improved system 180 which includes a camera 1 with the panoramic adapter 100 according to the present invention retrofitted into the XM101 Common Remotely Operated Weapon Station (CROWS), manufactured by Recon Optical, Inc. based in Barrington, II. More specifically, a camera with the panoramic adapter has been integrated with the CROWS Fire Control/Target Acquisition System (FC/TAS). Referring again to our example, FIG. 9 illustrates the raw images 10a and 10b the camera with adapter records on a single frame 52. The images are then processed and displayed to the operator of the modified CROWS system 180. FIG. 10 provides a photograph of a processed image 18 that is able to be displayed to the operator when the panoramic adapter and camera is added to the CROWS system. The image frame 18 represents 360 xyz coverage laid out onto a xy image format. Distortion is able to be removed and the image may be zoomed, panned, and rotated upon in a continuous manner by implementing additional image processing already discussed in this specification. FIG. 17 illustrates raw images 10a and 10b recorded by camera 1 with the panoramic adapter 100 which are displayed on the viewfinder 16 of the camera. The image processed from the raw image is displayed on the viewfinder 16′ of the wireless remote control device 109. The enlarged image of the person on the viewfinder 16′ of the wireless remote control viewfinder illustrates what a CROWS system can do when the present invention is integrated. The operator of the CROWS system operates his FC/TAS with the panoramic adapter 100 system to pan and zoom in on targets that surround the vehicle 176. In operation the operator of the CROWS weapon system operates the FC/TAS system equipped with the camera 1, panoramic adapter 100, and panoramic software or firmware 129 to display the resulting panoramic imagery and engage targets observed in that imagery.

One embodiment is that the operator operates the system to engage targets observed within the panoramic imagery using a flat panel display 183′ and joystick 184′ mounted inside the combat vehicle 176. A second embodiment is that the operator 185 wear a head mounted display system 183″ with a position sensing system 184″ that is integrated with the target acquisition and fire control system 182 to engage targets using the weapon system 181 observed within the panoramic imagery recorded by the camera 1 with adapter 100. Head mounted display systems 183″ and 184″ with head and eye tracking devices that transmit roll, pitch, yaw, and heading and xyz coordinates that are able to be received and operated on by a target acquisition and fire control system such as the CROWS system are well known within the art and are incorporated in the present invention. Again referring to FIG. 10 in order conceptualizes one application of using the panoramic imagery from the adapter. In order that the operator 185 of the CROWS system does not have to turn completely around to engage targets in a 360 xyz manner slight head movements are programmed into the FC&TAS to call up imagery that it would take more robust head movements to see. For instance, the operator turning his head 45 degrees horizontally will bring imagery recorded in the 180 horizontal plane into view, and the operator turning his head 90 degrees horizontally will bring 360 degree imagery recorded by the adapter into view. In this manner the operator of the FC/TAS can rapidly engage targets to the front, side, or rear of the combat vehicle. The imagery is preferably processed by the CROWS FC/TAS 182 with the panoramic adapter system 100 for the operator 185 such that he or she can observe any portion of the continuous spherical environment that surrounds the combat vehicle 176 the operator is enclosed within. It is anticipated by the present inventor that different types of camera systems will be used with the various embodiments of the present invention such as those with single and plural image sensors. And that the sensors incorporated into the panoramic camera mounted on the host vehicle may be on axis or off axis or on axis with the image sensors cooperating to record a panoramic scene without departing from the scope of the invention.

The present inventor has provided representative examples of the present invention. Patents with technologies of a type that are integrated into the present invention are also discussed in the following inventions: U.S. patent application Ser. No. 11/432,568 entitled “Volumetric Panoramic Sensor Systems” filed May 11, 2006; U.S. Patent Application Serial No. 20070182812 filed Aug. 9, 2007 entitled “Improved Panoramic Image-Based Virtual Reality/Telepresence Audio-Visual System and Method”; and U.S. Patent Application 20070002131 filed Jan. 4, 2007 entitled “Dynamic interactive region-of-interest panoramic/three dimensional immersive communication system and method” all filed on the present inventors behalf by Frank. C. Nicholas, Cardinal Law Group, 1603 Orrington, Suite 2000, Evanston, Ill. 60201, Ph. (847) 905-7111. The above applications art all of which in their entireities are hereby incorporated by reference as within the scope of the present invention.

The present optical system may be mounted on various cameras, including PDA and cellular phone cameras. The present optical system may be used on cameras used to record images for video teleconferencing and telepresence applications. The camera system the adapter is mounted upon must have the ability to focus on the image plane of the adapter in order to record the panoramic images. Other optical components may be added to the adapter without departing from the spirit of the invention. For instance, various types of magnifiers, rod lenses, beam splitters and shutter systems to record alternating images, audio systems, fiber optic image conduits. Various embodiments such as tailored camera holders, remote control and review devices may be incorporated that are compatible with the present invention and to facilitate panoramic photography/cinematography/videography using the adapter. Various image processing hardware and software besides that mentioned herein may be incorporated to process the images, such as distorting removal and stitching software, and panoramic viewing software. As disclosed and described, Copyright and Trademark protection of images may be included in the camera design by designing a copyrighted image into the viewing plane of the camera such that no panoramic images can be captured without also copying the copyrighted or trademarked logo. Alternatively, the adapter may be built into the camera in which case it is not an adapter, but becomes and integrated part of the camcorder. Additionally, it is anticipated a support stand may be designed to attach to the camera 1 with adapter to hold it in an advantage position for the panoramic adapter 100 to record imagery and receive and send control and video signals. It is also anticipated that a support stand could be integrated into the camera itself. In either case the support stand would have legs made of a material that can support the camera and attach to the camera, such as by connecting to the camera's conventional camera mount. The mount may be made to attach to various devices. And it is also anticipated that the sensors used in the present invention may be planar or three-dimensional with a single or plurality of image sensors, with various types of CCDs and CMOS devices. And it is anticipated that some of the embodiments, such as the image controller unit and stand to hold a panoramic camera, may be adapted to panoramic camera systems of somewhat different designs. Finally, it is anticipated that the system will be miniaturized, made portable, and integrated into various systems without departing from the scope of the present invention.

Based on the above specification and drawings I hereby claim the following:

1. A panoramic optical system comprising:
optical means including one or more objective and relay optics to focus at least one image representing at least some portion of a substantially spherical field-of-view scene in focus to an imaging plane;
housing means including support means to hold the optical means and
mounting means that attaches the panoramic optical system to an adjacent camera.

2. A panoramic camera system comprising:
optical means which includes at least one objective lens and relay optics to transmit at least one image representing some portion of a substantially spherical field-of-view scene in focus to an imaging plane, and housing means to hold the optical means and mounting means that attaches the adapter to said camera means in place; and
said camera means that attaches to said optical means in a communicating relationship such that the image or images recorded on the image plane of the optical means are able to be focused by said camera's taking lens system onto one or more sensors of said camera means.

3. The system according to claim 2 where the optical and housing means comprises a panoramic lens adapter that attaches onto the taking lens of a non-interchangeable lens camera.

4. The system according to claim 2 where optical and housing means comprises a panoramic lens adapter that attaches onto the taking lens of an interchangeable lens camera.

5. The system according to claim 2 where the panoramic optical system and camera are integrated into a single housing.

6. The system according to claim 2 where the objective lens means comprises two back to back fisheye lenses with greater that 180 degree field-of-view coverage which cooperate to record two hemispherical images that comprise a substantially spherical image.

7. The system according to claim 2 where the objective optics comprise four back to back fisheye lenses with greater that 180 degree field of view coverage which cooperate to record four hemispherical images that comprise images that may be used to provide two views of a scene for stereoscopic imaging.

8. The system according to claim 2 where the objective optics comprises at least one fisheye lens.

9. The system according to claim 2 where the camera's sensor has a region-of-interest address, processing, and readout capability.

10. The system according to claim 2 where the optical means include right angle prisms.

11. The system according to claim 2 where the optical means include fiber optic image conduits.

12. The system according to claim 2 where optical means include magnification means or reducing means to enlarge one or more images from an objective lens or relay optics.

13. The system according to claim 2 where the optical means include tapered fiber optic means for countering distortion and/or enlarging at least one or more images.

14. The system according to claim 2 wherein two hemispherical images are projected from said optical means within a 16:9 HDTV format in a manner to maximize their filling up the rectangular format by projecting the images opposite one another such that images edges are tangential to the edge of the rectangular format and adjacent to one another.

15. The system according to claim 2 wherein the hemispherical images are projected from said optical means within a 4:3 TV/video format in a manner to maximize their filling up the rectangular format by projecting the images in opposite corners of the rectangular format and such that images edges are tangential to the edge of the rectangular format and adjacent to one another.

16. The system according to claim 2 in which said optical means includes a beam splitter and electronic shutter system such that the shutter system is operated to select which image or images are and are not transmitted from different optical paths of the optical system for presentation to said camera.

17. A system according to claim 2 which includes a wireless remote control device for control of the camera means on which the panoramic optical system is mounted.

18. The system according to claim 2 which includes integrated image processing firmware for controlling an electronic shutter system built into in the panoramic optical system.

19. The system according to claim 2 which includes integrated image processing firmware for controlling said camera means for processing and viewing of said panoramic images.

20. The system according to claim 2 where the camera means on which the panoramic optical system is placed is a camcorder.
